(19) United States
(12) Patent Application Publication
(10) Pub. No.: US 2026/0205627 A1
(43) Pub. Date: Jul. 16, 2026

(54) Selective Update Operations in Lifting Wavelet Transform for 3D Mesh Displacements

(71) Applicant: Ofinno, LLC, Reston, VA (US)

(72) Inventor: Chao Cao, Centreville, VA (US)

(73) Assignee: Ofinno, LLC, Reston, VA (US)

(21) Appl. No.: 19/564,752

(22) Filed: Mar. 12, 2026

Related U.S. Application Data
(63) Continuation of application No. PCT/US2024/046469, filed on Sep. 12, 2024.
(60) Provisional application No. 63/538,008, filed on Sep. 12, 2023.

(51) Int. Cl. H04N 19/63; G06T 17/20; H04N 19/597

(52) U.S. Cl. CPC H04N 19/63; G06T 17/20; H04N 19/597

(57) ABSTRACT

A decoder receives, from a bitstream, first wavelet coefficients representing first displacements of first vertices, of a three-dimensional mesh, that are at a plurality of levels of detail (LODs). An indication, received from the bitstream, indicates whether an update weight, specific to an LOD of the LODs, in an update operation of a lifting operation corresponding to the LOD is set to zero. An inverse lifting wavelet transform is applied that iteratively performs, according to an order of the plurality of LODs, a lifting operation on second wavelet coefficients, from the first wavelet coefficients, associated with each LOD of the plurality of LODs to determine the first displacements. The update weight for the update operation in the lifting operation, corresponding to the LOD, is set based on the indication.

### CROSS-REFERENCE TO RELATED APPLICATIONS

This application is a continuation of International Application No. PCT/US2024/046469, filed Sep. 12, 2024, which claims the benefits of U.S. Provisional Application No. 63/538,008, filed Sep. 12, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary mesh coding/decoding system in which embodiments of the present disclosure may be implemented.

FIG. 2A illustrates a block diagram of an example encoder for intra encoding a 3D mesh, according to some embodiments.

FIG. 2B illustrates a block diagram of an example encoder for inter encoding a 3D mesh, according to some embodiments.

FIG. 3 illustrates a diagram showing an example decoder.

FIG. 4 is a diagram showing an example process for generating displacements of an input mesh (e.g., an input 3D mesh frame) to be encoded, according to some embodiments.

FIG. 5 illustrates an example process for approximating and encoding a geometry of a 3D mesh, according to some embodiments.

FIG. 6 illustrates an example of vertices of a subdivided mesh (e.g., a subdivided base mesh) corresponding to multiple levels of detail (LODs), according to some embodiments.

FIG. 7A illustrates an example of an image packed with displacements (e.g., displacement fields or vectors) using a packing method, according to some embodiments.

FIG. 7B illustrates an example of the displacement image with labeled LODs, according to some embodiments.

FIG. 8A illustrates an example of a lifting scheme for representing displacement information of a 3D mesh as wavelet coefficients, according to some embodiments.

FIG. 8B illustrates an example of a lifting scheme, for representing displacement information of a 3D mesh as wavelet coefficients, in which one or more update operations may be selectively performed, according to some embodiments.

FIG. 9A illustrates an example forward lifting scheme to transform displacements of a 3D mesh (e.g., a mesh frame of the 3D mesh) to wavelet coefficients, according to some embodiments.

FIG. 9B illustrates an example of inverse lifting scheme to transform wavelet coefficients to displacements of a 3D mesh, according to some embodiments.

FIG. 10 is a diagram that illustrates an example of iteratively performing the inverse lifting scheme for each of LODs of vertices in a 3D mesh, according to some embodiments.

FIG. 11 illustrates a flowchart of a method for performing a forward lifting scheme, according to some embodiments.

FIG. 12 illustrates a flowchart of a method for performing an inverse lifting scheme, according to some embodiments.

FIG. 13 illustrates a block diagram of an exemplary computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of pixels that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color. Compared to traditional visual data, volumetric visual data may provide a more immersive way to experience visual data. For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Volumetric visual data may be in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is three dimensional (3D) meshes (hereinafter referred to as a mesh or a mesh frame). A mesh frame (or mesh) comprises a collection of points in three-dimensional (3D) space, also referred to as vertices. Each vertex in a mesh comprises geometry information that indicates the vertex's position in 3D space. For example, the geometry information may indicate the vertex's position in 3D space using three Cartesian coordinates (x, y, and z). Further the mesh may comprise geometry information indicating a plurality of triangles. Each triangle comprises three vertices connected by three edges and a face. One or more types of attribute information may be stored for each face (of a triangle). Attribute information may indicate a property of a face's visual appearance. For example, attribute information may indicate a texture (e.g., color) of the face, a material type of the face, transparency information of the face, reflectance information of the face, a normal vector to a surface of the face, a velocity at the face, an acceleration at the face, a time stamp indicating when the face (and/or vertex) was captured, or a modality indicating how the face (and/or vertex) was captured (e.g., running, walking, or flying). In another example, a face (or vertex) may comprise light field data in the form of multiple view-dependent texture information. Light field data may be another type of optional attribute information.

The triangles (e.g., represented by vertexes and edges) in a mesh may describe an object or a scene. For example, the triangles in a mesh may describe the external surface and/or the internal structure of an object or scene. The object or scene may be synthetically generated by a computer or may be generated from the capture of a real-world object or scene. The geometry information of a real world object or scene may be obtained by 3D scanning and/or photogrammetry. 3D scanning may include laser scanning, structured light scanning, and/or modulated light scanning. 3D scanning may obtain geometry information by moving one or more laser heads, structured light cameras, and/or modulated light cameras relative to an object or scene being scanned. Photogrammetry may obtain geometry information by triangulating the same feature or point in different spatially shifted 2D photographs. Mesh data may be in the form of a mesh frame that describes an object or scene captured at a particular time instance or in the form of a sequence of mesh frames (referred to as a mesh sequence or mesh video) that describes an object or scene captured at multiple different time instances.

The data size of a mesh frame or sequence in addition with one or more types of attribute information may be too large for storage and/or transmission in many applications. For example, a single mesh frame may comprise thousands or tens or hundreds of thousands of triangles, where each triangle (e.g., vertexes and/or edges) comprises geometry information and one or more optional types of attribute information. The geometry information of each vertex may comprise three Cartesian coordinates (x, y, and z) that are each represented, for example, using 8 bits or 24 bits in total. The attribute information of each point may comprise a texture corresponding to three color components (e.g., R, G, and B color components) that are each represented, for example, using 8 bits or 24 bits in total. A single vertex therefore comprises 48 bits of information in this example, with 24 bits of geometry information and 24 bits of texture. Encoding may be used to compress the size of a mesh frame or sequence to provide for more efficient storage and/or transmission. Decoding may be used to decompress a compressed mesh frame or sequence for display and/or other forms of consumption (e.g., by a machine learning based device, neural network based device, artificial intelligence based device, or other forms of consumption by other types of machine based processing algorithms and/or devices).

Compression of meshes may be lossy (e.g., introducing differences relative to the original data) for the distribution to and visualization by an end-user, for example on AR/VR glasses or any other 3D-capable device. Lossy compression allows for a very high ratio of compression but incurs a trade-off between compression and visual quality perceived by the end-user. Other frameworks, like medical or geological applications, may require lossless compression to avoid altering the decompressed meshes.

Volumetric visual data may be stored after being encoded into a bitstream in a container, for example, a file server in the network. The end-user may request for a specific bitstream depending on the user's requirement. The user may also request for adaptive streaming of the bitstream where the trade-off between network resource consumption and visual quality perceived by the end-user is taken into consideration by an algorithm.

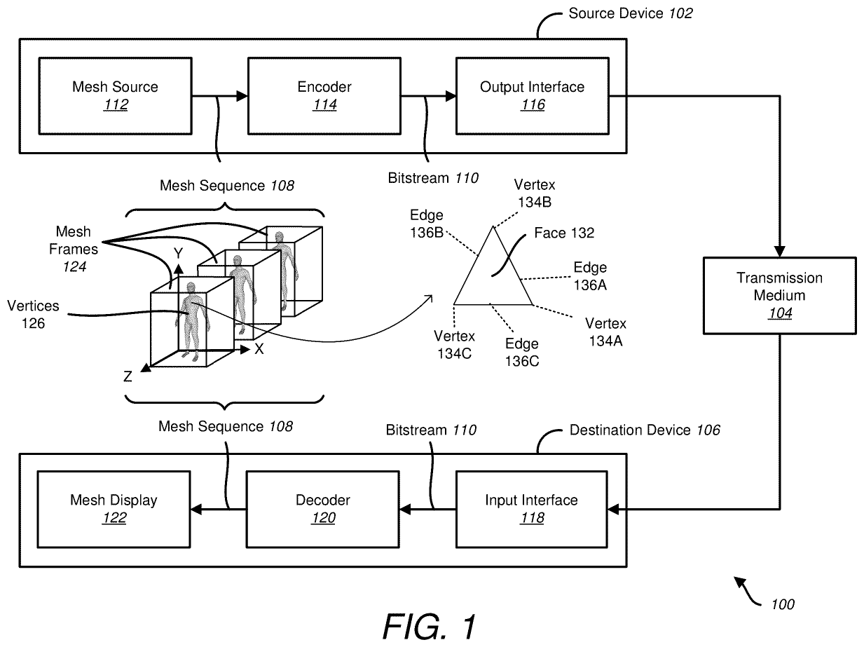

FIG. 1 illustrates an exemplary mesh coding/decoding system 100 in which embodiments of the present disclosure may be implemented. Mesh coding/decoding system 100 comprises a source device 102, a transmission medium 104, and a destination device 106. Source device 102 encodes a mesh sequence 108 into a bitstream 110 for more efficient storage and/or transmission. Source device 102 may store and/or transmit bitstream 110 to destination device 106 via transmission medium 104. Destination device 106 decodes bitstream 110 to display mesh sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming counsel) or may be fully self-contained.

To encode mesh sequence 108 into bitstream 110, source device 102 may comprise a mesh source 112, an encoder 114, and an output interface 116. Mesh source 112 may provide or generate mesh sequence 108 from a capture of a natural scene and/or a synthetically generated scene. A synthetically generated scene may be a scene comprising computer generated graphics. Mesh source 112 may comprise one or more mesh capture devices (e.g., one or more laser scanning devices, structured light scanning devices, modulated light scanning devices, and/or passive scanning devices), a mesh archive comprising previously captured natural scenes and/or synthetically generated scenes, a mesh feed interface to receive captured natural scenes and/or synthetically generated scenes from a mesh content provider, and/or a processor to generate synthetic mesh scenes.

As shown in FIG. 1, a mesh sequence 108 may comprise a series of mesh frames 124. A mesh frame describes an object or scene captured at a particular time instance. Mesh sequence 108 may achieve the impression of motion when a constant or variable time is used to successively present mesh frames 124 of mesh sequence 108. A (3D) mesh frame comprises a collection of vertices 126 in 3D space and geometry information of vertices 126. A 3D mesh may comprise a collection of vertices, edges, and faces that define the shape of a polyhedral object. Further, the mesh frame comprises a plurality of triangles (e.g., polygon triangles). For example, a triangle may include vertices 134A-C and edges 136A-C and a face 132. The faces usually consist of triangles (triangle mesh), Quadrilaterals (Quads), or other simple convex polygons (n-gons), since this simplifies rendering, but may also be more generally composed of concave polygons, or even polygons with holes. Each of vertices 126 may comprise geometry information that indicates the point's position in 3D space. For example, the geometry information may indicate the point's position in 3D space using three Cartesian coordinates (x, y, and z). For example, the geometry information may indicated the plurality of triangles with each comprising three vertices of vertices 126. One or more of the triangles may further comprise one or more types of attribute information. Attribute information may indicate a property of a point's visual appearance. For example, attribute information may indicate a texture (e.g., color) of a face, a material type of a face, transparency information of a face, reflectance information of a face, a normal vector to a surface of a face, a velocity at a face, an acceleration at a face, a time stamp indicating when a face was captured, a modality indicating when a face was captured (e.g., running, walking, or flying). In another example, one or more of the faces (or triangles) may comprise light field data in the form of multiple view-dependent texture information. Light field data may be another type of optional attribute information. Color attribute information of one or more of the faces may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

In some embodiments, a 3D mesh (e.g., one of mesh frames 124) may be a static or a dynamic mesh. In some examples, the 3D mesh may be represented (e.g., defined) by connectivity information, geometry information, and texture information (e.g., texture coordinates and texture connectivity). In some embodiments, the geometry information may represent locations of vertices of the 3D mesh in 3D space and the connectivity information may indicate how the vertices are to be connected together to form polygons (e.g., triangles) that make up the 3D mesh. Also, the texture coordinates indicate locations of pixels in a 2D image that correspond to vertices of a corresponding 3D mesh (or a sub-mesh of the 3D mesh). In some examples, patch information may indicate how the texture coordinates defined with respect to a 2D bounding box map into a 3D space of a 3D bounding box associated with the patch based on how the points were projected onto a projection plane for the patch. Also, the texture connectivity information may indicate how the vertices represented by the texture coordinates are to be connected together to form polygons of the 3D mesh (or sub-meshes). For example, each texture or attribute patch of the texture image may corresponds to a corresponding sub-mesh defined using texture coordinates and texture connectivity.

In some embodiments, for each 3D mesh, one or multiple 2D images may represent the textures or attributes associated with the mesh. For example, the texture information may include geometry information listed as X, Y, and Z coordinates of vertices and texture coordinates listed as 2D dimensional coordinates corresponding to the vertices. The example texture mesh may include texture connectivity information that indicates mappings between the geometry coordinates and texture coordinates to form polygons, such as triangles. For example, a first triangle may be formed by three vertices, where a first vertex is defined as the first geometry coordinate (e.g. 64.062500, 1237.739990, 51.757801), which corresponds with the first texture coordinate (e.g. 0.0897381, 0.740830). A second vertex of the triangle may be defined as the second geometry coordinate (e.g. 59.570301, 1236.819946, 54.899700), which corresponds with the second texture coordinate (e.g. 0.899059, 0.741542). Finally, a third vertex of the triangle may correspond to the third listed geometry coordinate which matches with the third listed texture coordinate. However, note that in some instances a vertex of a polygon, such as a triangle may map to a set of geometry coordinates and texture coordinates that may have different index positions in the respective lists of geometry coordinates and texture coordinates. For example, the second triangle has a first vertex corresponding to the fourth listed set of geometry coordinates and the seventh listed set of texture coordinates. A second vertex corresponding to the first listed set of geometry coordinates and the first set of listed texture coordinates and a third vertex corresponding to the third listed set of geometry coordinates and the ninth listed set of texture coordinates.

Encoder 114 may encode mesh sequence 108 into bitstream 110. To encode mesh sequence 108, encoder 114 may apply one or more prediction techniques to reduce redundant information in mesh sequence 108. Redundant information is information that may be predicted at a decoder and therefore may not be needed to be transmitted to the decoder for accurate decoding of mesh sequence 108. For example, encoder 114 may convert attribute information (e.g., texture information) of one or more of mesh frames 124 from 3D to 2D and then apply one or more 2D video encoders or encoding methods to the 2D images. For example, any one of multiple different proprietary or standardized 2D video encoders/decoders may be used, including International Telecommunications Union Telecommunication Standardization Sector (ITU-T) H.1263, ITU-T H.1264 and Moving Picture Expert Group (MPEG)-4 Visual (also known as Advanced Video Coding (AVC)), ITU-T H.1265 and MPEG-H Part 2 (also known as High Efficiency Video Coding (HEVC), ITU-T H.1265 and MPEG-I Part 3 (also known as Versatile Video Coding (VVC)), the WebM VP8 and VP9 codecs, and AOMedia Video 1 (AV1). Encoder 114 may encode geometry of mesh sequence 108 based on video dynamic mesh coding (V-DMC). V-DMC specifies the encoded bitstream syntax and semantics for transmission or storage of a mesh sequence and the decoder operation for reconstructing the mesh sequence from the bitstream.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into mesh sequence 108 for display or other forms of consumption, destination device 106 may comprise an input interface 118, a decoder 120, and a mesh display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode mesh sequence 108 from encoded bitstream 110. To decode attribute information (e.g., textures) of mesh sequence 108, decoder 120 may reconstruct the 2D images compressed using one or more 2D video encoders. Decoder 120 may then reconstruct the attribute information of 3D mesh frames 124 from the reconstructed 2D images. In some examples, decoder 120 may decode a mesh sequence that approximates mesh sequence 108 due to, for example, lossy compression of mesh sequence 108 by encoder 114 and/or errors introduced into encoded bitstream 110 during transmission to destination device 106. Further, decoder 120 may decode geometry of mesh sequence 108 from encoded bitstream 110, as will be further described below. Then, one or more of decoded attribute information may be applied to decoded mesh frames of mesh sequence 108.

Mesh display 122 may display mesh sequence 108 to a user. Mesh display 122 may comprise a cathode rate tube (CRT) display, a liquid crystal display (LCD), a plasma display, a light emitting diode (LED) display, a 3D display, a holographic display, a head mounted display, or any other display device suitable for displaying mesh sequence 108.

It should be noted that mesh coding/decoding system 100 is presented by way of example and not limitation. In the example of FIG. 1, mesh coding/decoding system 100 may have other components and/or arrangements. For example, mesh source 112 may be external to source device 102. Similarly, mesh display 122 may be external to destination device 106 or omitted altogether where mesh sequence is intended for consumption by a machine and/or storage device. In another example, source device 102 may further comprise a mesh decoder and destination device 106 may comprise a mesh encoder. In such an example, source device 102 may be configured to further receive an encoded bit stream from destination device 106 to support two-way mesh transmission between the devices.

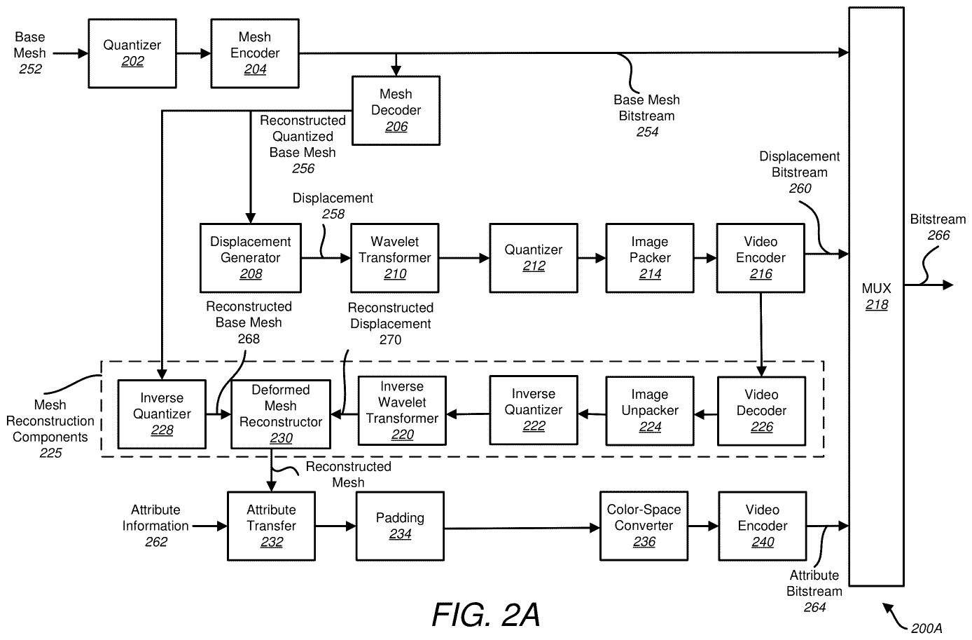

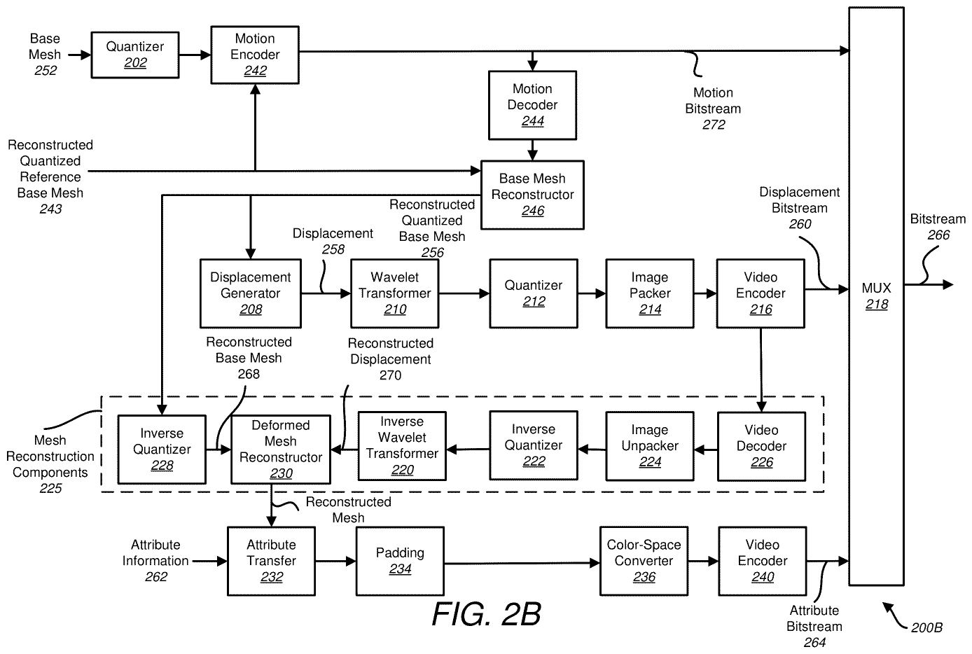

FIG. 2A illustrates a block diagram of an example encoder 200A for intra encoding a 3D mesh, according to some embodiments. For example, an encoder (e.g., encoder 114) may comprise encoder 200A.

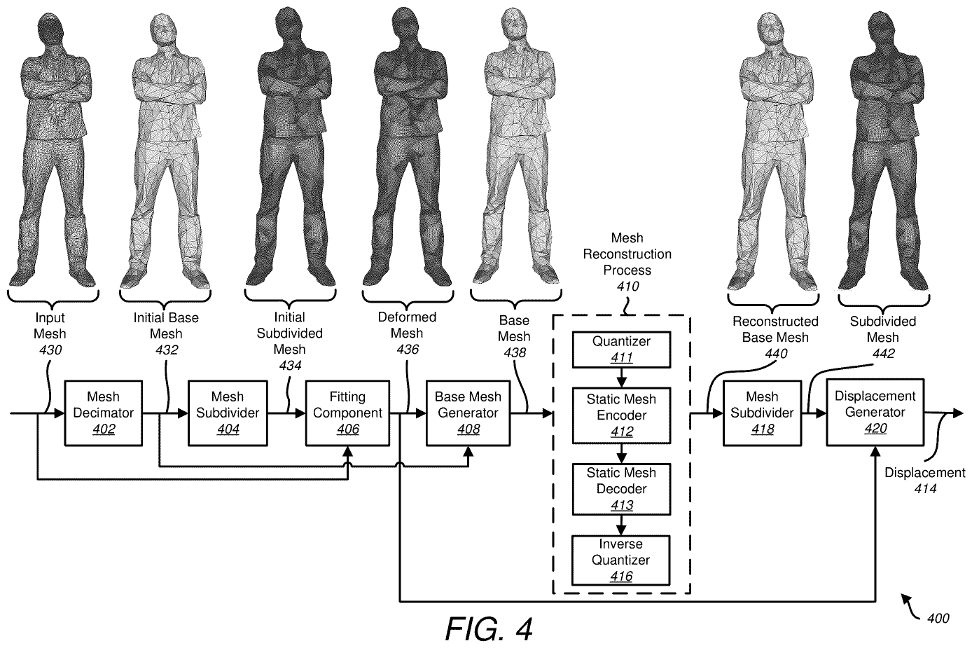

In some examples, a mesh sequence (e.g., mesh sequence 108) may include a set of mesh frames (e.g., mesh frames 124) that may be individually encoded and decoded. As will be further described below with respect to FIG. 4, a base mesh 252 may be determined (e.g., generated) from a mesh frame (e.g., an input mesh) through a decimation process. In the decimation process, the mesh topology of the mesh frame may be reduced to determine to the base mesh (e.g., a decimated mesh or decimated base mesh). A mesh encoder 204 may encode base mesh 252, whose geometry information (e.g., vertices) may quantized by quantizer 202, to generate a base mesh bitstream 254. In some examples, base mesh encoder 204 may be an existing encoder such as Draco or Edgebreaker.

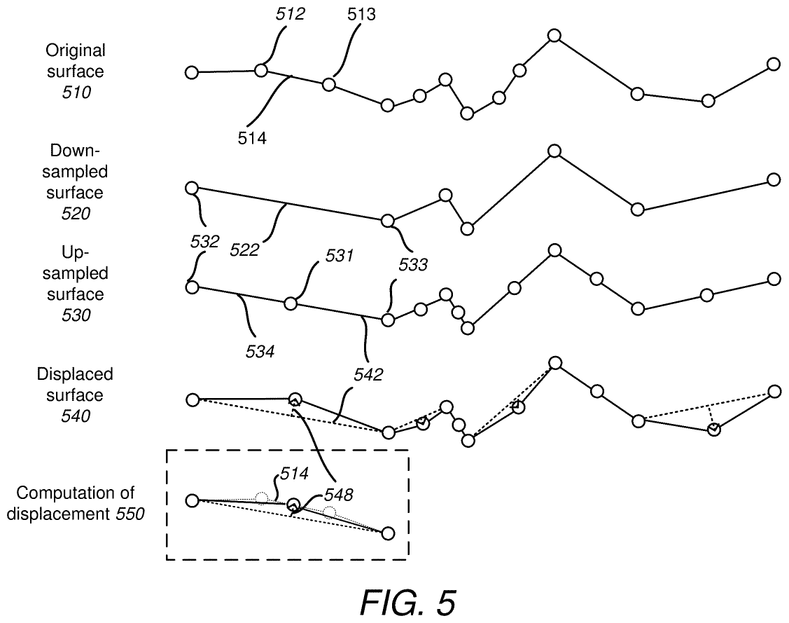

Displacement generator 208 may generate displacements for vertices of the mesh frame based on base mesh 252, as will be further explained below with respect to FIGS. 4 and 5. In some examples, the displacements are determined based on a reconstructed base mesh 256. Reconstructed base mesh 256 may be determined (e.g., output or generated) by mesh decoder 206 that decodes the encoded base mesh (e.g., in base mesh bitstream 254) determined (e.g., output or generated) by mesh encoder 204. Displacement generator 208 may subdivide reconstructed base mesh 256 using a subdivision scheme (e.g., subdivision algorithm) to determine a subdivided mesh (e.g., a subdivided base mesh). Displacement 258 may be determined based on fitting the subdivided mesh to an original input mesh surface. For example, displacement 258 for a vertex in the mesh frame may include displacement information (e.g., a displacement vector) that indicates a displacement from the position of the corresponding vertex in the subdivided mesh to the position of the vertex in the mesh frame.

Displacement 258 may be transformed by wavelet transformer 210 to generate wavelet coefficients (e.g., transformation coefficients) representing the displacement information and that may be more efficiently encoded (and subsequently decoded). The wavelet coefficients may be quantized by quantizer 212 and packed (e.g., arranged) by image packer 214 into a picture (e.g., one or more images or picture frames) to be encoded by video encoder 216. Mux 218 may combine (e.g., multiplex) the displacement bitstream 260 output by video encoder 216 together with base mesh bitstream 254 to form bitstream 266.

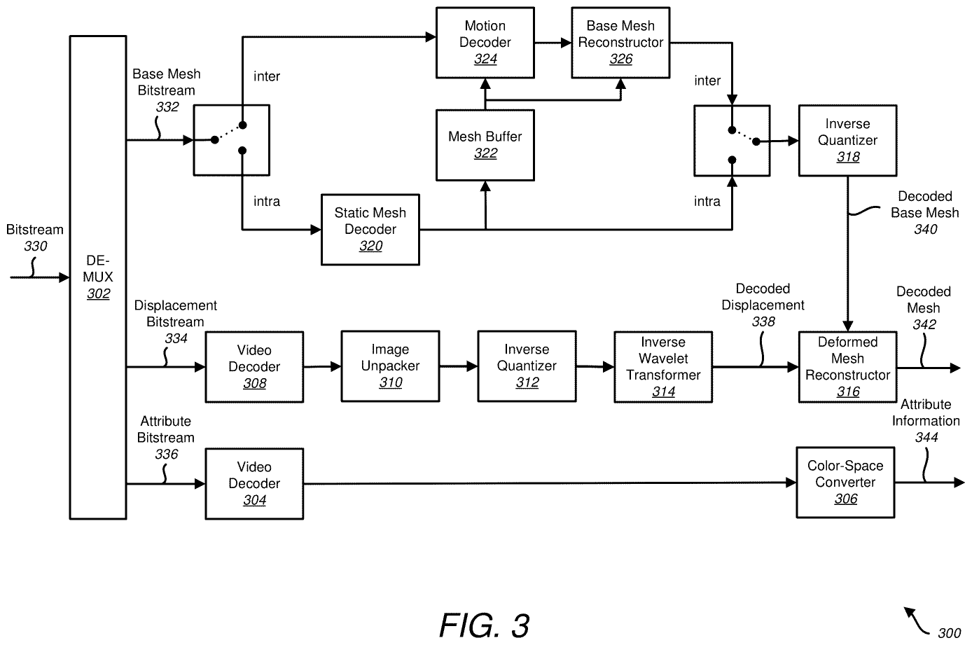

Attribute information 262 (e.g., color, texture, etc.) of the mesh frame may be encoded separately from the geometry information of the mesh frame described above. In some examples, attribute information 262 of the mesh frame may be represented (e.g., stored) by an attribute map (e.g., texture map) that associates each vertex of the mesh frame with corresponding attributes information of that vertex. Attribute transfer 232 may re-parameterize attribute information 262 in the attribute map based on reconstructed mesh determined (e.g., generated or output) from mesh reconstruction components 225. Mesh reconstruction components 225 perform inverse or decoding functions and may be the same or similar components in a decoder (e.g., decoder 300 of FIG. 3). For example, inverse quantizer 228 may inverse quantize reconstructed base mesh 256 to determine (e.g., generate or output) reconstructed base mesh 268. Video decoder 226, image unpacker 224, inverse quantizer 222, and inverse wavelet transformer 220 may perform the inverse functions as that of video encoder 216, image packer 214, quantizer 212, and wavelet transformer 210, respectively. Accordingly, reconstructed displacement 270, corresponding to displacement 258, may be generated from applying video decoder 226, image unpacker 224, inverse quantizer 222, and inverse wavelet transformer 220 in that order. Deformed mesh reconstructor 230 may determine the reconstructed mesh, corresponding to the input mesh frame, based on reconstructed base mesh 268 and reconstructed displacement 270. In some examples, the reconstructed mesh may be the same decoded mesh determined from the decoder based on decoding base mesh bitstream 254 and displacement bitstream 260.

Attribute information of the re-parameterized attribute map may be packed in images (e.g., 2D images or picture frames) by padding component 234. Padding component 234 may fill (e.g., pad) portions of the images that do not contain attribute information. In some examples, color-space converter 236 may translate (e.g., convert) the representation of color (e.g., an example of attribute information 262) from a first format to a second format (e.g., from RGB444 to YUV420) to achieve improved rate-distortion (RD) performance when encoding the attribute maps. In an example, color-space converter 236 may also perform chroma subsampling to further increase encoding performance. Finally, video encoder 240 encodes the images (e.g., pictures frames) representing attribute information 262 of the mesh frame to determine (e.g., generate or output) attribute bitstream 264 multiplexed by mux 218 into bitstream 266. In some examples, video encoder 240 may be an existing 2D video compression encoder such as an HEVC encoder or a VVC encoder.

FIG. 2B illustrates a block diagram of an example encoder 200B for inter encoding a 3D mesh, according to some embodiments. For example, an encoder (e.g., encoder 114) may comprise encoder 200B. As shown in FIG. 2B, encoder 200B comprises many of the same components as encoder 200A. In contrast to encoder 200A, encoder 200B does not include mesh encoder 204 and mesh decoder 206, which correspond to coders for static 3D meshes. Instead, encoder 200B comprises a motion encoder 242, a motion decoder 244, and a base mesh reconstructor 246. Motion encoder 242 may determine a motion field (e.g., one or more motion vectors (MVs)) that, when applied to a reconstructed quantized reference base mesh 243, best approximates base mesh 252.

The determined motion field may be encoded in bitstream 266 as motion bitstream 272. In some examples, the motion field (e.g., a motion vector in the x, y, and z directions) may be entropy coded as a codeword (e.g., for each directional component) resulting from a coding scheme such as a unary, a Golomb code (e.g., Exp-Golomb code), a Rice code, or a combination thereof. In some examples, the codeword may be arithmetically coded, e.g., using CABAC. A prefix part of the codeword may be context coded and a suffix part of the coded may be bypass codded. In some examples, a sign bit for each directional component of the motion vector may be coded separately.

In some examples, motion bitstream 272 may further include indication of the selected reconstructed quantized reference base mesh 243.

In some examples, motion bitstream 272 may be decoded by motion decoder 244 and used by base mesh reconstructor 246 to generate reconstructed quantized base mesh 256. For example, base mesh reconstructor 246 may apply the decoded motion field to reconstructed quantized reference base mesh 243 to determine (e.g., generate) reconstructed quantized base mesh 256.

In some examples, a reconstructed quantized reference base mesh m′(j) associated with a reference mesh frame with index j may be used to predict the base mesh m(i) associated with the current frame with index i. Base meshes m(i) and m(j) may comprise the same: number of vertices, connectivity, texture coordinates, and texture connectivity. The positions of vertices may differ between base meshes m(i) and m(j).

In some examples, the motion field f(i) may be computed by considering the quantized version of m(i) and the reconstructed quantized base mesh m′(j). Base mesh m′(j) may have a different number of vertices than m(j) (e.g., vertices may have been merged or removed). Therefore, the encoder may track the transformation applied to m(j) to determine (e.g., generate or obtain) m′(j) and apply it to m(i). This transformation may enable a 1-to-1 correspondence between vertices of base mesh m′(j) and the transformed and quantized version of base mesh m(i), denoted as m\hat{ }*(i). The motion field f(i) may be computed by subtracting the quantized positions p(i,v) of the vertex v of m\hat{ }*(i) from the positions Pos(j,v) of the vertex v of m′(j) as follows: f(i,v)=Pos(i,v)−Pos(j,v). The motion field may be further predicted by using the connectivity information of base mesh m′(j) and the prediction residuals may be entropy encoded.

In some examples, since the motion field compression process may be lossy, a reconstructed motion field denoted as f′(i) may be computed by applying the motion decoder component. A reconstructed quantized base mesh m′(i) may then be computed by adding the motion field to the positions of vertices in base mesh m′(j). To better exploit temporal correlation in the displacement and attribute map images (e.g., sequence/video of images), inter prediction may be enabled in the video encoder.

In some embodiments, an encoder (e.g., encoder 114) may comprise encoder 200A and encoder 200B.

FIG. 3 illustrates a diagram showing an example decoder 300. Bitstream 330, which may correspond to bitstream 266 in FIGS. 2A and 2B and may be received in a binary file, may be demultiplexed by de-mux 302 to separate bitstream 330 into base mesh bitstream 332, displacement bitstream 334, and attribute bitstream 336 carrying base mesh geometry information, displacement geometry information, and attribute information, respectively. Attribute bitstream 336 may include one or more attribute map sub-streams for each attribute type.

In some examples, for inter decoding, the bitstream is de-multiplexed into separate sub-streams, including: a motion sub-stream, a displacement sub-stream for positions and potentially for each vertex attribute, zero or more attribute map sub-streams, and an atlas sub-stream containing patch information in the same manner as in V3C/V-PCC

In some examples, base mesh bitstream 332 may be decoded in an intra mode or an inter mode. In the intra mode, static mesh decoder 320 may decode base mesh bitstream 332 (e.g., to generate reconstructed base mesh m′(i)) that is then inverse quantized by inverse quantizer 318 to determine (e.g., generate or output) decoded base mesh 340 (e.g., reconstructed quantized base mesh m″(i)). In some examples, static mesh decoder 320 may correspond to mesh decoder 206 of FIG. 2A.

In some examples, in the inter mode, base mesh bitstream 332 may include motion field information that is decoded by motion decoder 324. In some examples, motion decoder 324 may correspond to motion decoder 244 of FIG. 2B. For example, motion decoder 324 may entropy decode base mesh bitstream 332 to determine motion field information. In the inter mode, base mesh bitstream 332 may indicate a previous base mesh (e.g., reference base mesh m′(j)) decoded by static mesh decoder 320 and stored (e.g., buffered) in mesh buffer 322. Base mesh reconstructor 326 may generate a quantized reconstructed base mesh m′(i) by applying the decoded motion field (output by motion decoder 324) to the previously decoded (e.g., reconstructed) base mesh m′(j) stored in mesh buffer 322. In some examples, base mesh reconstructor 326 may correspond to base mesh reconstructor 246 of FIG. 2B. The quantized reconstructed base mesh may be inverse quantized by inverse quantizer 318 to determine (e.g., generate or output) decoded base mesh 340 (e.g., reconstructed base mesh m″(i)). In some examples, decoded base mesh 340 may be the same as reconstructed base mesh 268 in FIGS. 2A and 2B.

In some examples, decoder 300 includes video decoder 308, image unpacker 310, inverse quantizer, and inverse wavelet transformer 314 that determines (e.g., generates) decoded displacement 338 from displacement bitstream 334. Video decoder 308, image unpacker 310, inverse quantizer, and inverse wavelet transformer 314 correspond to video decoder 226, image unpacker 224, inverse quantizer 222, and inverse wavelet transformer 220, respectively, and perform the same or similar operations. For example, the picture frames (e.g., images) received in displacement bitstream 334 may be decoded by video decoder 308, the displacement information may be unpacked by image unpacker 310 from the decoded image, inverse quantized by inverse quantizer 312 to determined inverse quantized wavelet coefficients representing encoded displacement information. Then, the unquantized wavelet coefficients may be inverse transformed by inverse wavelet transformer 314 to determine decoded displacement d″(i). In other words decoded displacement 338 (e.g., decoded displacement field d″(i)) may be the same as reconstructed displacement 270 in FIGS. 2A and 2B.

Deformed mesh reconstructor 316, which corresponds to deformed mesh reconstructor 230, may determine (e.g., generate or output) decoded mesh 342 (M″(i)) based on decoded displacement 338 and decoded base mesh 340. For example, deformed mesh reconstructor 316 may combine (e.g., add) decoded displacement 338 to a subdivided decoded mesh 340 to determine decoded mesh 342.

In some examples, decoder 300 includes video decoder 304 that decodes attribute bitstream 336 comprising encoded attribute information represented (e.g., stored) in 2D images (or picture frames) to determined attribute information 344 (e.g., decoded attribute information or reconstructed attribute information). In some examples, video decoder 304 may be an existing 2D video compression decoder such as an HEVC decoder or a VVC decoder. Decoder 300 may include a color-space converter 306, which may revert the color format transformation performed by color-space converter 236 in FIGS. 2A and 2B.

FIG. 4 is a diagram 400 showing an example process (e.g., a pre-processing operations) for generating displacements 414 of an input mesh 430 (e.g., an input 3D mesh frame) to be encoded, according to some embodiments. In some examples, displacements 414 may correspond to displacement 258 shown in FIG. 2A and FIG. 2B.

In diagram 400, a mesh decimator 402 determines (e.g., generates or outputs) an initial base mesh 432 based on (e.g., using) input mesh 430. In some examples, the initial base mesh 432 may be determined (e.g., generated) from the input mesh 432 through a decimation process. In the decimation process, the mesh topology of the mesh frame may be reduced to determine the initial base mesh (which may be referred to as a decimated mesh or decimated base mesh). As will be illustrated in FIG. 5, the decimation process may involve a down sampling process to remove vertices from the input mesh 432 so that a small portion (e.g., 6% or less) of the vertices in the input mesh 430 may remain in the initial base mesh 432.

Mesh subdivider 404 applies a subdivision scheme to generate initial subdivided mesh 434. As will be discussed in more detail with regard to FIG. 5, the subdivision scheme may involve upsampling the initial base mesh 432 to add more vertices to the 3D mesh based on the topology and shape of the original mesh to generate the initial subdivided mesh 434.

Fitting component 406 may fit the initial subdivided mesh to determine a deformed mesh 436 that may more closely approximate the surface of input mesh 430. As will be discussed in more detail with respect to FIG. 5, the fitting may be performed by moving vertices of the initial subdivided mesh 434 towards the surfaces of the input mesh 430 so that the subdivided mesh 434 can be used to approximate the input mesh 430. In some implementations, the fitting is performed by moving each vertex of the initial subdivided mesh 434 along the normal direction of the vertex until the vertex intersects with a surface of the input mesh 430. The resulting mesh is the deformed mesh 436. The normal direction may be indicated by a vertex normal at the vertex, which may be obtained from face normals of triangles formed by the vertex.

Base mesh generator 408 may perform another fitting process to generate a base mesh 438 from the initial base mesh 432. For example, the base mesh generator 408 may deform the initial base mesh 432 according to the deformed mesh 436 so that the initial base mesh 432 is close to the deformed mesh 436. In some implementations, the fitting process may be performed in a similar manner to the fitting component 406. For example, the base mesh generator 408 may move each of the vertices in the initial base mesh 432 along its normal direction (e.g., based on the vertex normal at each vertex) until the vertex reaches a surface of the deformed mesh 436. The output of this process is the base mesh 438.

Base mesh 438 may be output to a mesh reconstruction process 410 to generate a reconstructed base mesh 440. Reconstructed base mesh 440 may be subdivided by mesh subdivider 418 and the subdivided mesh 442 may be input to displacement generator 420 to generate (e.g., determine or output) displacement 414, as further described below with respect to FIG. 5. In some examples, mesh subdivider 418 may apply the same subdivision scheme as that applied by mesh subdivider 404. In these examples, vertices in the subdivided mesh 442 have a one-to-one correspondence with the vertices in the deformed mesh 436. As such, the displacement generator 420 may generate the displacements 414 by calculating the difference between each vertex of the subdivided mesh 442 and the corresponding vertex of the deformed mesh 436. In some implementations, the difference may be projected onto a normal direction of the associated vertex and the resulting vector is the displacement 414. In this way, only the sign and magnitude of the displacement 414 need to be encoded in the bitstream, thereby increasing the coding efficiency. In addition, because the base mesh 438 has been fitted toward the deformed mesh 436, the displacements 414 between the deformed mesh 436 and the subdivided mesh 442 (generated from the reconstructed base mesh 440) will have small magnitudes, which further reduces the payload and increases the coding efficiency.

In some examples, one advantage of applying the subdivision process is to allow for more efficient compression, while offering a faithful approximation of the original input mesh 430 (e.g., surface or curve of the original input mesh 430). The compression efficiency may be obtained because the base mesh (e.g., decimated mesh) has a lower number of vertices compared to the number of vertices of input mesh 430 and thus requires a fewer number of bits to be encoded and transmitted. Additionally, the subdivided mesh may be automatically generated by the decoder once the base mesh has been decoded without any information needed from the encoder other than a subdivision scheme (e.g., subdivision algorithm) and parameters for the subdivision (e.g., a subdivision iteration count). The reconstructed mesh may be determined by decoding displacement information (e.g., displacement vectors) associated with vertices of the subdivided mesh (e.g., subdivided curves/surfaces of the base mesh). Not only does the subdivision process allow for spatial/quality scalability, but also the displacements may be efficiently coded using wavelet transforms (e.g., wavelet decomposition), which further increases compression performance.

In some embodiments, mesh reconstruction process 410 includes components for encoding and then decoding base mesh 438. FIG. 4 shows an example for the intra mode, in which mesh reconstruction process 410 may include quantizer 411, static mesh encoder 412, static mesh decoder 413, and inverse quantizer 416, which may perform the same or similar operations as quantizer 202, mesh encoder 204, mesh decoder 206, and inverse quantizer 228, respectively, from FIG. 2A. For the inter mode, mesh reconstruction process 410 may include quantizer 202, motion encoder 242, motion decoder 244, base mesh reconstructor 246, and inverse quantizer 228.

FIG. 5 illustrates an example process for approximating and encoding a geometry of a 3D mesh, according to some embodiments. For illustrative purposes, the 3D mesh is shown as 2D curves. An original surface 510 of the 3D mesh (e.g., a mesh frame) includes vertices (e.g., points) and edges that connect neighboring vertices. For example, point 512 and point 513 are connected by an edge corresponding to surface 514.

In some examples, a decimation process (e.g., a down-sampling process or a decimation/down-sampling scheme) may be applied to an original surface 510 of the original mesh to generate a down-sampled surface 520 of a decimated (or down-sampled) mesh. In the context of mesh compression, decimation refers to the process of reducing the number of vertices in a mesh while preserving its overall shape and topology. For example, original mesh surface 510 is decimated into a surface 520 with fewer samples (e.g., vertices and edges) but still retains the main features and shape of the original mesh surface 510. This down-sample surface 520 may correspond to a surface of the base mesh (e.g., a decimated mesh).

In some examples, after the decimation process, a subdivision process (e.g., subdivision scheme or subdivision algorithm) may be applied to down-sampled surface 520 to generate an up-sampled surface 530 with more samples (e.g., vertices and edges). Up-sampled surface 530 may be part of the subdivided mesh (e.g., subdivided base mesh) resulting from subdividing down-sampled surface 520 corresponding to a base mesh.

Subdivision is a process that is commonly used after decimation in mesh compression to improve the visual quality of the compressed mesh. The subdivision process involves adding new vertices and faces to the mesh based on the topology and shape of the original mesh. In some examples, the subdivision process starts by taking the reduced mesh that was generated by the decimation process and iteratively adding new vertices and edges. For example, the subdivision process may comprise dividing each edge (or face) of the reduced/decimated mesh into shorter edges (or smaller faces) and creating new vertices at the points of division. These new vertices are then connected to form new faces (e.g., triangles, quadrilaterals, or another polygon). By applying subdivision after the decimation process, a higher level of compression can be achieved without significant loss of visual fidelity. Various subdivision schemes may be used such as, e.g., mid-point, Catmull-Clark subdivision, Butterfly subdivision, Loop subdivision, etc., or a combination thereof.

For example, FIG. 5 illustrates an example of the mid-point subdivision scheme. In this scheme, each subdivision iteration subdivides each triangle into four sub-triangles. New vertices are introduced in the middle of each edge. The subdivision process may be applied independently to the geometry and to the texture coordinates since the connectivity for the geometry and for the texture coordinates are usually different. The subdivision scheme computes the position Pos(v₁₂) of a newly introduced vertex v₁₂ at the center of an edge (v₁, v₂) formed by a first vertex (v₁) and a second vertex (v₂), as follows:

$$Pos ( {v}_{12} ) = \frac{1}{2} ( Pos ( {v}_{1} ) + Pos ( {v}_{2} ) ) ,$$

where Pos(v₁) and Pos(v₂) are the positions of the vertices v₁ and v₂. In some examples, the same process may be used to compute the texture coordinates of the newly created vertex. For normal vectors, a normalization step may be applied as follows:

$$N ( {v}_{12} ) = \frac{N ( {v}_{1} ) + N ( {v}_{2} )}{‖ N ( {v}_{1} ) + N ( {v}_{2} ) ‖} ,$$

N(v₁₂), N(v₁), and N(v₂) are the normal vectors associated with the vertices v₁₂, v₁, and v₂, respectively. ∥x∥ is the norm2 of the vector x.

Using the mid-point subdivision scheme, as shown in up-sampled surface 530, point 531 may be generated as the mid-point of edge 522 which is an edge connecting point 532 and point 533. Point 531 may be added as a new vertex. Edge 534 and edge 542 are also added to connect the added new vertex corresponding to point 531. In some examples, the original edge 522 may be replaced by two new edges 534 and 542.

In some examples, down-sampled surface 520 may be iteratively subdivided to generate up-sampled surface 530. For example, a first subdivided mesh resulting from a first iteration of subdivision applied to down-sampled surface 520 may be further subdivided according to the subdivision scheme to generate a second subdivided mesh, etc. In some examples, a number of iterations corresponding to levels of subdivision may be predetermined. In other examples, an encoder may indicate the number of iterations to a decoder, which may similarly generate a subdivided mesh, as further described above.

In some embodiments, the subdivided mesh may be deformed towards (e.g., approximates) the original mesh to determine (e.g., get or obtain) a prediction of the original mesh having original surface 510. The points on the subdivided mesh may be moved along a computed normal vertex/orientation until it reaches an original surface 510 of the original mesh. The distance between the intersected point on the original surface 510 and the subdivided point may be computed as a displacement (e.g., a displacement vector). For example, point 531 may be moved towards the original surface 510 along a computed normal orientation of surface (e.g., represented by edge 542). When point 531 intersects with surface 514 of the original surface 510 (of original/input mesh), a displacement vector 548 can be computed. Displacement vector 548 applied to point 531 may result in displaced surface 540, which may better approximate original surface 510. In some examples, displacement information (e.g., displacement vector 548) for vertices of the subdivided mesh (e.g., up-sampled surface 530 of subdivided mesh) may be encoded and transmitted in displacement bitstream 260 shown in examples encoders of FIGS. 2A and 2B. Note, as explained with respect to FIG. 4, the subdivided mesh corresponding to up-sampled surface may be subdivided mesh 442 that is compared to deformed mesh 436 representative of original surface 510 of the input mesh.

In some embodiments, displacements d(i) (e.g., a displacement field or displacement vectors) may be computed and/or stored based on local coordinates or global coordinates. For example, a global coordinate system is a system of reference that is used to define the position and orientation of objects or points in a 3D space. It provides a fixed frame of reference that is independent of the objects or points being described. The origin of the global coordinate system may be defined as the point where the three axes intersect. Any point in 3D space can be located by specifying its position relative to the origin along the three axes using Cartesian coordinates (x, y, z). For example, the displacements may be defined in the same cartesian coordinate system as the input or original mesh.

In a local coordinate system, a normal, a tangent, and/or a binormal vector (which are mutually perpendicular) may be determined that defines a local basis for the 3D space to represent the orientation and position of an object in space relative to a reference frame. In some examples, displacement field d(i) may be transformed from the canonical coordinate system to the local coordinate system, e.g., defined by a normal to the subdivided mesh at each vertex (e.g., commonly referred to as a vertex normal). The normal at each vertex may be obtained from combining the face normals of triangles formed by the vertex. In some examples, using the local coordinate system may enable further compression of tangential components of the displacements compared to the normal component.

In some embodiments, a decoder (e.g., decoder 300 of FIG. 3) may receive and decode a base mesh corresponding to (e.g., having) down-sampled surface 520. Similar to the encoder, the decoder may apply a subdivision scheme to determine a subdivided mesh having up-sampled surface 530 generated from down-sampled surface 520. The decoder may receive and decode displacement information including displacement vector 548 and determine a decoded mesh (e.g., reconstructed mesh) based on the subdivided mesh (corresponding to up-sampled surface 530) and the decoded displacement information. For example, the decoder may add the displacement at each vertex with a position of the corresponding vertex in the subdivided mesh. The decoder may obtain a reconstructed 3D mesh by combining the obtained/decoded displacements with positions of vertices of the subdivided mesh.

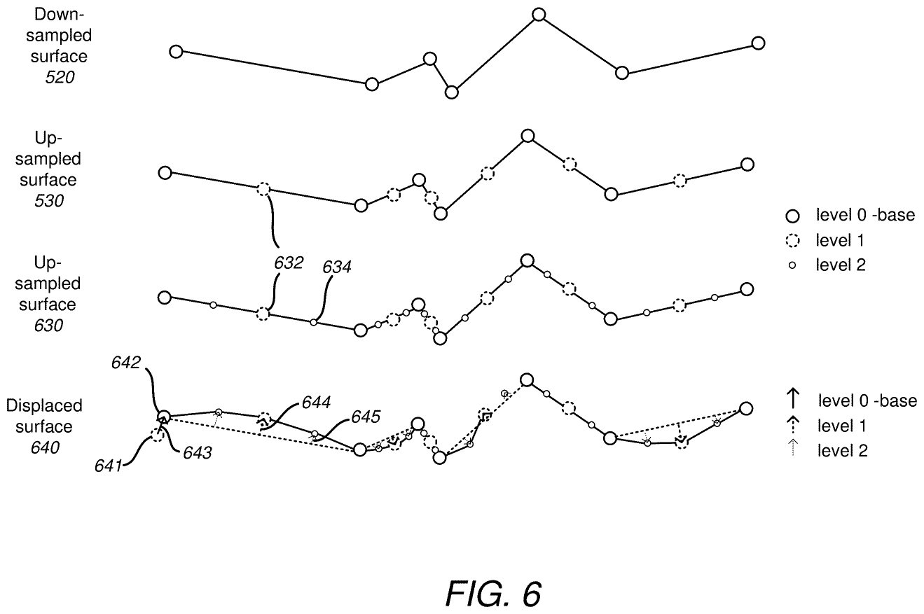

FIG. 6 illustrates an example of vertices of a subdivided mesh (e.g., a subdivided base mesh) corresponding to multiple levels of detail (LODs), according to some embodiments. As described above with respect to FIG. 5, the subdivision process (e.g., subdivision scheme) may be an iterative process, in which a mesh can be subdivided multiple times and a hierarchical data structure is generated containing multiple levels. Each level of the hierarchical data structure may include different numbers of data samples (e.g., vertices and edges in mesh) representing (e.g., forming) different density/resolution (e.g., also referred to as levels of details (LoDs)). For example, a down-sampled surface 520 (of a decimated mesh) can be subdivided into up-sampled surface 530 after a first iteration of subdivision. Up-sampled surface 530 may be further subdivided into up-sampled surface 630 and so forth. In this case, vertices of the mesh with down-sampled surface 520 may be considered as being in or associated with LOD0. Vertices, such as vertex 632, generated in up-sampled surface 530 after a first iteration of subdivision may be at LOD1. Vertices, such as vertex 634, generated in up-sampled surface 630 after another iteration of subdivision may be at LOD2, etc. In some examples, an LOD0 may refer to the vertices resulting from decimation of an input (e.g., original) mesh resulting in a base mesh with (e.g., having) down-sampled surface 520. For example, vertices at LOD0 may be vertices of a reconstructed quantized base mesh 256 of FIGS. 2A-B, reconstructed/decoded base mesh 340 of FIG. 3, reconstructed base mesh 440 of FIG. 4.

In some examples, the computation of displacements in different LODs follows the same mechanism as described above with respect to FIG. 5. In some examples, a displacement vector 643 may be computed from a position of a vertex 641 in the original surface 510 (of original mesh) to a vertex 642, from displace surface 640 of the deformed mesh, at LOD0. The displacement vectors 644 and 645 of corresponding vertices 632 and 634 from LOD1 and LOD 2, respectively, may be similarly calculated. Accordingly, in some examples, a number of iterations of subdivision may correspond to a number of LODs and one of the iterations may correspond to one LOD of the LODs.

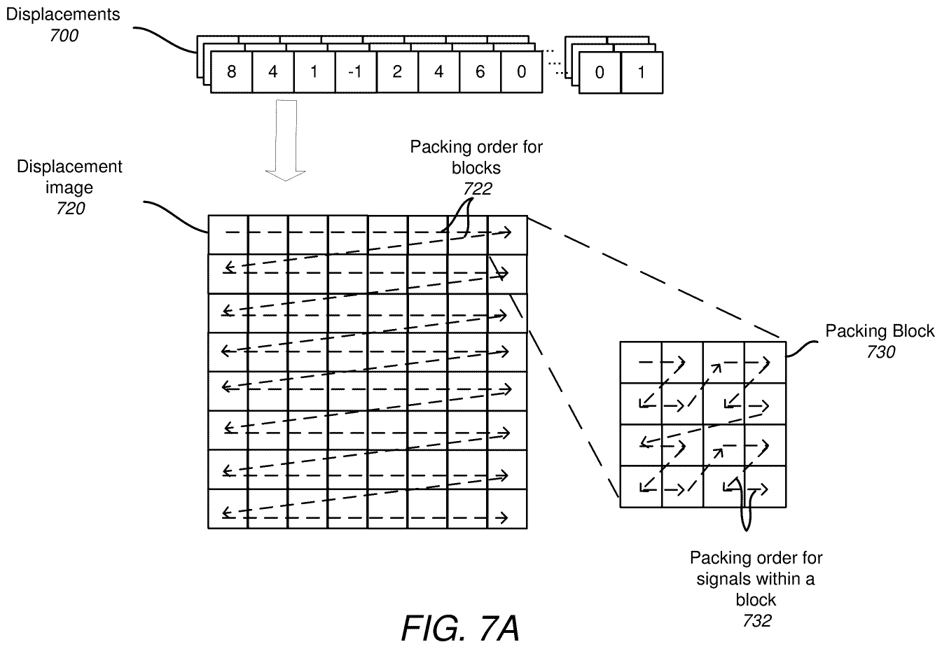

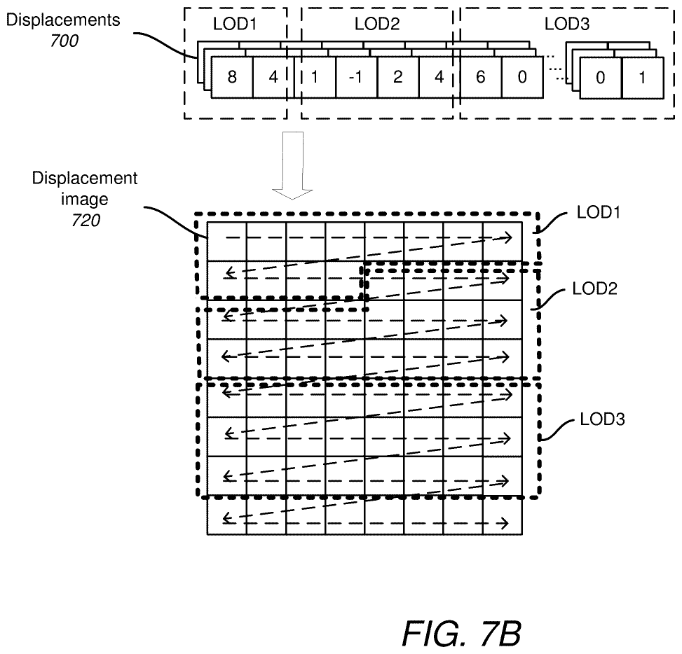

FIG. 7A illustrates an example of an image 720 (e.g., picture or a picture frame) packed with displacements 700 (e.g., displacement fields or vectors) using a packing method (e.g., a packing scheme or a packing algorithm), according to some embodiments. Specifically, displacements 700 may be generated, as described above with respect to FIG. 5 and FIG. 6, and packed into 2D images. In some examples, a displacement can be a 3D vector containing the values for the three components of the distance. For example, a delta x value represents the shift on the x-axis from a point A to a point B in a Cartesian coordinate system. In some examples, a displacement vector may be represented by less than three components, e.g., by one or two components. For example, when a local coordinate system is used to store the displacement value, one component with the highest significance may be stored as being representative of the displacement and the other components may be discarded.

In some examples, as will be further described below, a displacement value may be transformed into other signal domains for achieving better compression. For example, a displacement can be wavelet transformed and be decomposed into and represented as wavelet coefficients (e.g., coefficient values or transform coefficients). In these examples, displacements 700 that are packed in image 720 may comprise the resulting wavelet coefficients (e.g., transform coefficients), which may be more efficiently compressed than the un-transformed displacement values. At the decoder side, a decoder may decode displacements 700 as wavelet coefficients and may apply an inverse wavelet transform process to reconstruct the original displacement values obtained at the encoder.

In some examples, one or more of displacements 700 may be quantized by the encoder before being packed into displacement image 720. In some examples, one or more displacements may be quantized before being wavelet transformed, after being wavelet transformed, or quantized before and after being wavelet transformed. For example, FIG. 7A shows quantized wavelet transform values 8, 4, 1, −1, etc. in displacements 700. At the decoder side, the decoder may perform inverse quantization to reverse or undo the quantization process performed by the encoder.

In general, quantization in signal processing may be the process of mapping input values from a larger set to output values in a smaller set. It is often used in data compression to reduce the amount, the precision, or the resolution of the data into a more compact representation. However, this reduction can lead to a loss of information and introduce compression artifacts. The choice of quantization parameters, such as the number of quantization levels, is a trade-off between the desired level of precision and the resulting data size. There are many different quantization techniques, such as uniform quantization, non-uniform quantization, and adaptive quantization that may be selected/enabled/applied. They can be employed depending on the specific requirements of the application.

In some examples, wavelet coefficients (e.g., displacement coefficients representing displacement signals) may be adaptively quantized according to LODs. As explained above, a mesh may be iteratively subdivided to generate a hierarchical data structure comprising multiple LODs. In this example, each vertex and its associated displacement belong to the same level of hierarchy in the LOD structure, e.g., an LOD corresponding to a subdivision iteration in which that vertex was generated. In some examples, a vertex at each LOD may be quantized according to quantization parameters, corresponding to LODs, that specify different levels of intensity/precision of the signal to be quantized. For example, wavelet coefficients in LOD 3 may have a quantization parameter of, e.g., 42 and wavelet coefficients in LOD 0 may have a different, smaller quantization parameter of 28 to preserve more detail information in LOD 0.

In some examples, displacements 700 may be packed onto the pixels in a displacement image 720 with a width W and a height H. In an example, a size of displacement image 720 (e.g., W multiplied by H) may be greater or equal to the number of components in displacements 700 to ensure all displacement information may be packed. In some examples, displacement image 720 may be further partitioned into smaller regions (e.g., squares) referred to as a packing block 730. In an example, the length of packing block 730 may be an integer multiple of 2.

Displacements 700 (e.g., displacement signals represented by quantized wavelet coefficients) may be packed into a packing block 730 according to a packing order 732. Each packing block 730 may be packed (e.g., arranged or stored) in displacement image 720 according to a packing order 722. Once all the displacements 700 are packed, the empty pixels in image 720 may be padded with neighboring pixel values for improved compression. In the example shown in FIG. 7A, packing order 722 for packing blocks may be a raster order and a packing order 732 for displacements within packing block 730 may be, for example, a Z-order. However, it should be understood that other packing schemes both for blocks and displacements within blocks may be used. In some embodiments, a packing scheme for the blocks and/or within the blocks may be predetermined. In some embodiments, the packing scheme may be signaled by the encoder in the bitstream per patch, patch group, tile, image, or sequence of images. Relatedly, the signaled packing scheme may be obtained by the decoder from the bitstream.

In some examples, packing order 732 may follow a space-filling curve, which specifies a traversal in space in a continuous, non-repeating way. Some examples of space-filling curve algorithms (e.g., schemes) include Z-order curve, Hilbert Curve, Peano Curve, Moore Curve, Sierpinski Curve, Dragon Curve, etc. Space-filling curves have been used in image packing techniques to efficiently store and retrieve images in a way that maximizes storage space and minimizes retrieval time. Space-filling curves are well-suited to this task because they can provide a one-dimensional representation of a two-dimensional image. One common image packing technique that uses space-filling curves is called the Z-order or Morton order. The Z-order curve is constructed by interleaving the binary representations of the x and y coordinates of each pixel in an image. This creates a one-dimensional representation of the image that can be stored in a linear array. To use the Z-order curve for image packing, the image is first divided into small blocks, typically 8×8 or 16×16 pixels in size. Each block is then encoded using the Z-order curve and stored in a linear array. When the image needs to be retrieved, the blocks are decoded using the inverse Z-order curve and reassembled into the original image.

In some examples, once packed, displacement image 720 may be encoded and decoded using a conventional 2D video codec.

FIG. 7B illustrates an example of displacement image 720, according to some embodiments. As shown, displacements 700 packed in displacement image 720 may be ordered according to their LODs. For example, displacement coefficients (e.g., quantized wavelet coefficients) may be ordered from a lowest LOD to a highest LOD. In other words, a wavelet coefficient representing a displacement for a vertex at a first LOD may be packed (e.g., arranged and stored in displacement image 720) according to the first LOD. For example, displacements 700 may be packed from a lowest LOD to a highest LOD. Higher LODs represent a higher density of vertices and corresponds to more displacements compared to lower LODs. The portion of displacement image 720 not in any LOD may be a padded portion.

In some examples, displacements may be packed in inverse order from highest LOD to lowest LOD. In an example, the encoder may signal whether displacements are packed from lowest to highest LOD or from highest to lowest LOD.

In some examples, a wavelet transform may be applied to displacement values to generate wavelet coefficients (e.g., displacement coefficients) that may be more easily compressed. Wavelet transforms are commonly used in signal processing to decompose a signal into a set of wavelets, which are small wave-like functions allowing them to capture localized features in the signal. The result of the wavelet transform is a set of coefficients that represent the contribution of each wavelet at different scales and positions in the signal. It is useful for detecting and localizing transient features in a signal and is generally used for signal analysis and data compression such as image, video, and audio compression.

Taking a 2D image as an example, wavelet transform is used to decompose an image (signals) into two discrete components, known as approximations/predictions and details. The decomposed signals are further divided into a high frequency component (details) and a low frequency component (approximations/predictions) by passing through two filters, high and low pass filters. In the example of 2D image, two filtering stages, a horizontal and a vertical filtering are applied to the image signals. A down-sampling step is also required after each filtering stage on the decomposed components to obtain the wavelet coefficients resulting in four sub-signals in each decomposition level. The high frequency component corresponds to rapid changes or sharp transitions in the signal, such as an edge or a line in the image. On the other hand, the low frequency component refers to global characteristics of the signal. Depending on the application, different filtering and compression can be achieved. There are various types of wavelets such as Haar, Daubechies, Symlets, etc., each with different properties such as frequency resolution, time localization, etc.

In signal processing, a lifting scheme is a technique for both designing wavelets and performing the discrete wavelet transform (DWT). It is an alternative approach to the traditional filter bank implementation of the DWT that offers several advantages in terms of computational efficiency and flexibility. It decomposes the signal using a series of lifting steps such that the input signal, e.g., displacements for 3D meshes, may be converted to displacement coefficients in-place. In the lifting scheme, a series of lifting operations (e.g. lifting steps) may be performed. Each lifting operation involves a prediction step (e.g., prediction operation) and an update step (e.g., update operation). These lifting operations may be applied iteratively to obtain the wavelet coefficients.

In various implementations of 3D mesh coding, displacements for 3D mesh frames may be transformed using a wavelet transform with lifting, e.g., referred to as a lifting scheme. Specifically, the wavelet transform may “split” the input signal (e.g., a displacement signal) into two signals: the even-samples signal E and the odd-sample O signal. The even samples E may comprise two displacement signals E₁ and E₂ associated with two vertices that are considered to be on an edge of the vertex associated with the input displacement signal. The odd sample O may represent an input signal corresponding to that vertex. As explained above, the edge information may be determined (e.g., generated or received) from the subdivision scheme applied to each mesh frame of the 3D mesh.

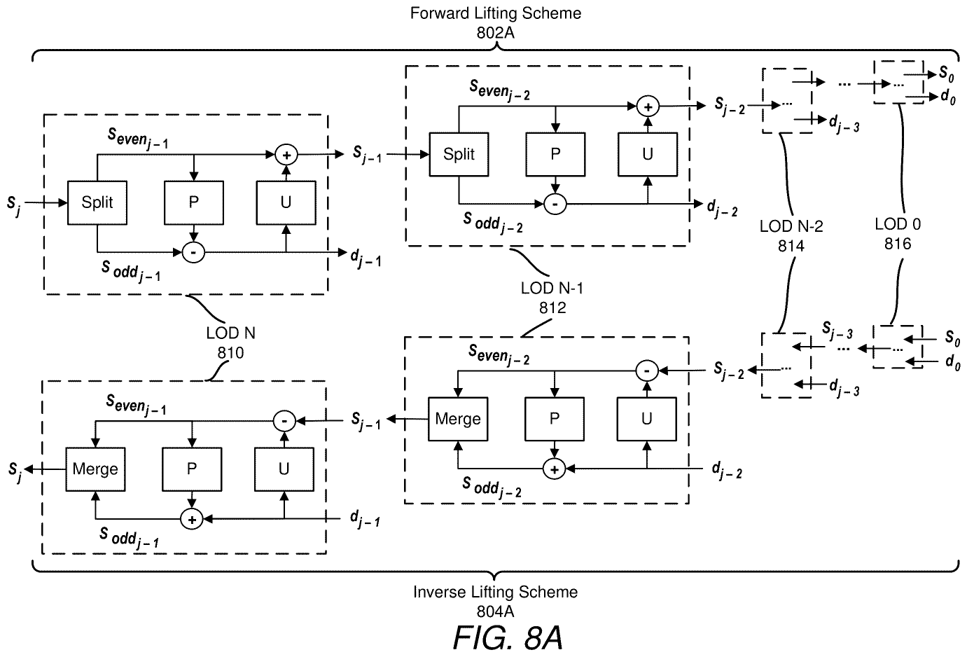

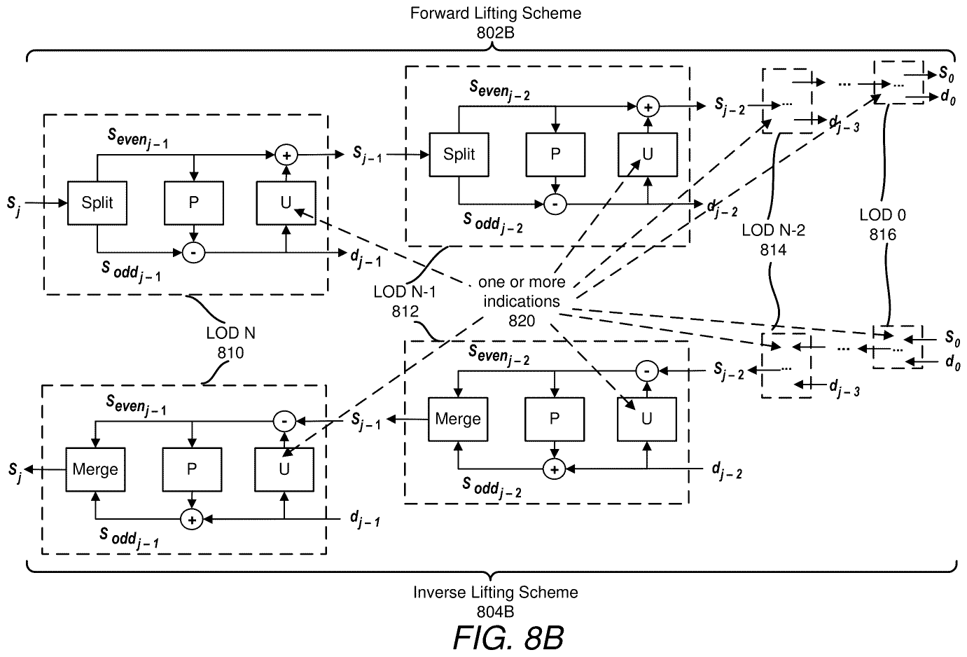

FIG. 8A illustrates an example of a lifting scheme for representing displacement information of a 3D mesh as wavelet coefficients, according to some embodiments. The lifting scheme may refer to a forward lifting scheme 802A and/or an inverse lifting scheme 804A. The lifting scheme comprises a plurality of lifting operations, which may be iteratively performed. Each lifting operation may include a prediction operation (e.g., prediction step) and an update operation (e.g., an update step). An encoder may perform (e.g., apply) forward lifting scheme 802A to determine (e.g., derive, generate, or obtain) wavelet coefficients representing displacement information. A decoder may perform (e.g., apply) inverse lifting scheme 804A to reverse the operations of forward lifting scheme to determine (e.g., derive, generate, or obtain) the displacement information from wavelet coefficients decoded from a bitstream. As explained above, the decoded displacement information may include displacement values (e.g., displacement vectors) corresponding to vertices of the mesh frame, which may be used by the decoder to generate a decoded mesh (e.g., a reconstructed mesh).

In some examples, forward lifting scheme 802A includes a splitting operation (e.g., a splitting step labeled as a “Split” component) that splits (e.g., separates) signal sⱼ (j≥1) into two signals (e.g., non-overlapping signals): the even-samples signal denoted by sₑᵥₑₙ_{ₖ} (k∈[0, j−1]) and the odd-samples signal denoted by soddy. Signal sⱼ represents the displacement values (e.g., displacement signals) determined for vertices of the 3D mesh frame. For example, a displacement value comprises a displacement field (e.g., a displacement vector), which may be one, two, or three components, as explained above.

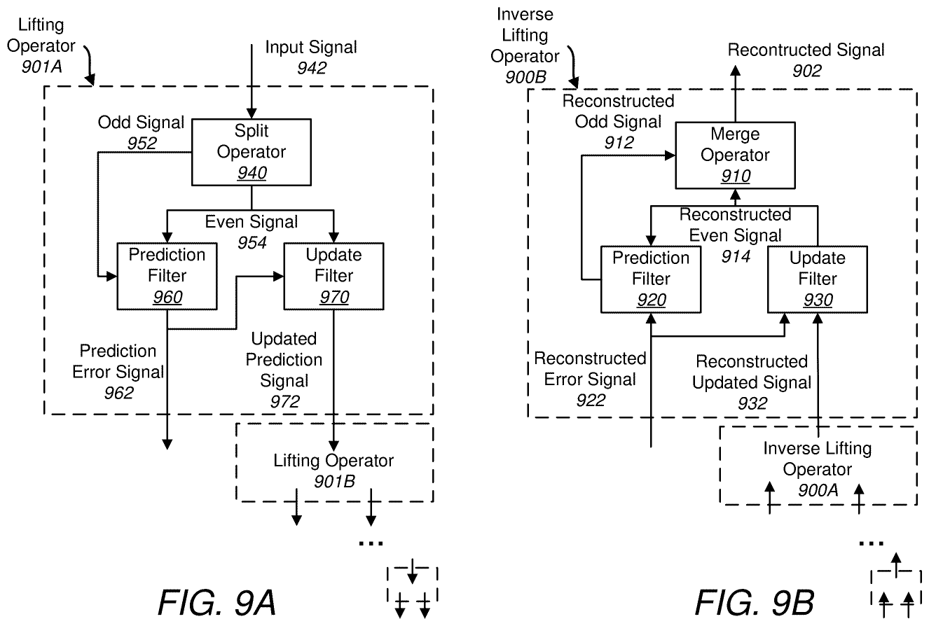

Forward lifting scheme 802A comprises a plurality of iterations corresponding to a plurality of LODs, e.g., shown as LOD_{N} 810, LOD_{N-1} 812, LOD_{N-2} 814, and LOD₀ 816. Each iteration of forward lifting scheme 802A (e.g., four iterations are shown as four dotted boxes corresponding to LODs 810-816) includes a prediction operation (e.g., a prediction step shown as “P” block/step) that determines (e.g., computes) a prediction for the odd samples based on the even samples. The prediction may be subtracted from the odd samples (e.g., shown as circles with negative signs) to create/generate a prediction error, e.g., error signal dₖ. Forward lifting scheme 802A also includes an update operation (e.g., an update step shown as “U” block/step) that recalibrates the low-frequency signals (e.g., corresponding to signals at lower LODs) with some of the energy removed during the subsampling. In the case of classical lifting, this is used in order to prepare the even signals for the next prediction operation in the next iteration of forward lifting scheme 802A. For example, the update operation updates (e.g., prepares) the even signals based on the error signal dₖ representing a difference between odd sample soddy and a corresponding predicted odd sample. In some examples, the update operation may update the even signal sₑᵥₑₙ_{ₖ} based on adding the prediction error dₖ to each of the even signal sₑᵥₑₙ_{ₖ} (e.g., shown as circle with positive signs). In some examples, the prediction error dₖ may be adjusted by an update weight, as will be further described below in FIGS. 9A-B and 10, and the even signal may be updated based on the adjusted prediction error.

In some embodiments, a decoder performs inverse lifting scheme 804A to reverse the operations of forward lifting scheme 802A. For example, whereas forward lifting scheme 802A comprises lifting operations that are iteratively performed from higher LODs (e.g., LOD_{N} 810) to lower LODs (e.g., LOD₀ 816), inverse lifting scheme 804A comprises lifting operations that are iteratively performed from lower LODs (e.g., LOD₀ 816) to higher LODs (e.g., LOD_{N} 810). In contrast to forward lifting scheme 802A, an update operation, in each lifting operation of inverse lifting scheme 804A, may subtract prediction error dₖ from even samples sₑᵥₑₙ_{ₖ} to update the even samples. In some examples, the prediction error dₖ may be adjusted by an update weight, as will be further described below in FIGS. 9A-B and 10, and the even signal may be updated based on the adjusted prediction error. A prediction operation, in each lifting operation of inverse lifting scheme 804A, may determine a reconstructed predicted odd sample s_{odd}_{ₖ}, e.g., based on a combination (e.g., summing or averaging) the updated even signals sₑᵥₑₙ_{ₖ}. Each lifting operation of inverse lifting scheme 804A combines (e.g., shown as circles with positive signs) the reconstructed predicted odd sample soddy with the prediction error dₖ to determine (e.g., generate or obtain) a displacement signal s_{odd}_{ₖ} corresponding to a displacement value determined at the encoder. In other words, the plurality of iterations of inverse lifting scheme 804A converts the wavelet coefficients, generated by the encoder and representing displacement information, into displacement values that may be used to reconstruct the mesh frame. Further, to revert the splitting operation of forward lifting scheme 802A, each lifting operation of inverse lifting scheme 804A includes a merge operation that merges (e.g., orders or combines in a sequence of signals or values) the updated even samples sₑᵥₑₙ_{ₖ} with the reconstructed odd sample s_{odd}_{ₖ}.

Note that the value j in FIG. 8A corresponds to a number of iterations for the lifting operations which varies depending on the specific requirement of the application. For example, the number of levels in LOD defined by the mesh decimation process may be used for the lifting operations. In some examples, a mid-point subdivision scheme may be used in the mesh decimation process. In these examples, since each vertex in a higher LOD level is a generated mid-point of an edge defined by two vertices in lower LOD levels, the signal (e.g., displacement value or its wavelet coefficient representation) associated with that vertex may be decomposed and represented by two sub-signals (e.g., displacement values or their wavelet coefficient representations) which belong to the corresponding two vertices. For example, a vertex v in LOD₁ (e.g., an LOD of level 1) may be the mid-point of two vertices v₁ and v₂ in LOD₀ (e.g., an LOD of level 0). In this example, the displacement associated with v can be wavelet transformed by using the lifting scheme. For an odd signal s_{odd}_{ₖ} corresponding to vertex v (e.g., the signal being the displacement signal or its wavelet coefficient representation), the even samples sₑᵥₑₙ_{ₖ} determined for odd signal soddy may correspond to vertices v₁ and v₂ (e.g., the signals being displacement signals or their wavelet coefficient representations) from which vertex v was generated.

In the lifting scheme, prediction weight and update weight are the coefficient values used to modify the input data during the prediction and update steps, respectively. The prediction weight may be a scalar value or a set of coefficients that define the linear combination of the neighboring signals used for prediction while the update weight determines the contribution of the prediction error to the final updated value. For example, the prediction may be determined from two input even samples based on a prediction weight equal to one half, which effectively averages signal values of the two input even samples. The prediction and update weights are often selected to satisfy certain properties or conditions to achieve desired characteristics in the transformed data. For example, in lossless lifting schemes, the weights may be designed to ensure perfect reconstruction of the original signal. In lossy lifting schemes, the weights may be selected to achieve specific frequency response characteristics or to minimize distortion based on the compression or denoising requirements.

In various implementations of 3D mesh coding, the prediction weight and the update weight may be determined (e.g., selected) for the lifting scheme, applied to displacements for vertices of a 3D mesh (e.g., each mesh frame of a sequence of mesh frames), such as to balance accuracy and properties resulting from the wavelet transforms corresponding to the displacements. As explained above, prediction operations of each iteration of the inverse lifting scheme may be dependent on (e.g., impacted by) updated signals inputs to the prediction operation. However, the update operation is not guaranteed to have positive compression impact for the following prediction operation of the displacement signal in the next iteration corresponding to (e.g., representing) the next LOD level. Due to characteristics and geometry of the mesh frame, characteristics at each LOD may not be the same. Therefore, always applying an update weight may results in reduced compression for displacements (e.g., displacement signals) for vertices at certain LODs.

Embodiments of the present disclosure are directed to applying selectively enabling or disabling (e.g., skipping) one or more update operations in the lifting operations of a lifting scheme applied to displacements for vertices of 3D meshes (e.g., mesh frames of a sequence of mesh frames of a 3D mesh). Each iteration of lifting operation may correspond to an LOD level of a plurality of LODs of vertices of a 3D mesh. In some examples, one or more indications may be encoded that indicates which update operations of a plurality of update operations in the lifting scheme are enabled (e.g., conversely indicating disabled or skipped). For example, the one or more indication may indicate one or more LODs corresponding to the update operations that are to be enabled (or disabled). In an example, the one or more indication may comprise one or more flags or one more syntax elements. Since the prediction error is not guaranteed to have a positive contribution to the precision of the reconstructed displacement signal and the update operation controls the contribution of the prediction error to be applied, selectively enabling/skipping an update operation may results in reducing the coding complexity and a more accurate prediction.

These and other embodiments are described herein.

FIG. 8B illustrates an example of a lifting scheme, for representing displacement information of a 3D mesh as wavelet coefficients, in which one or more update operations may be selectively performed, according to some embodiments. This lifting scheme may refer to forward lifting scheme 802B (e.g., performed by an encoder or wavelet transformer 210 of FIG. 2A and/or FIG. 2B) and/or inverse lifting scheme 804B (e.g., performed by a decoder or inverse wavelet transformer 314 of FIG. 3), which correspond to forward lifting scheme 802A and inverse lifting scheme 804A, respectively. Similarly, forward lifting scheme 802B and inverse lifting scheme 804B comprise a plurality of lifting operations that correspond to LODs 810-816. In forward lifting scheme 802B, the lifting operations are iteratively applied (e.g., performed) to displacement signals of vertices from higher LODs to lower LODs. In inverse lifting scheme 804B, the lifting operations are iteratively applied (e.g., performed) to displacement signals of vertices from lower LODs to higher LODs.

In contrast to the lifting scheme described in FIG. 8A, the lifting scheme of FIG. 8B shows one or more indications 820 (e.g., one or more flags or one or more syntax elements) that indicate which of update operations corresponding to LODs are enabled (or disabled or skipped). In some embodiments, the encoder may generate and signal (e.g., encode), in a bitstream, one or more indications 820 based on comparing compression results between one or more update operations, corresponding to one or more LODs, being disabled and enabled. The encoder may set one or more indications 820 to enable/disable a set of update operations to minimize the compression costs (e.g., maximizes compression gains). A decoder that applies (e.g., implements and/or performs) inverse lifting scheme 804B may receive and decode, from the bitstream, one or more indications 820 signaled by the encoder. Then, the decoder may determine which of the update operations, if any, are to be enabled (and relatedly which update operations are to be disabled).

In some examples, because each iteration of the lifting scheme are performed for each LOD level, one or more indications 820 may indicate one or more LODs to indicate which update operations are to be enabled (or disabled/skipped). For example, one or more indications 820 may comprise indexes of LODs whose update operations are enabled (or alternatively disabled/skipped). For example, one or more indications 820 may indicate that the update operation in lifting operation corresponding to LOD_{N} 810 are disabled (e.g., skipped or not enabled). During application of inverse lifting scheme 804B, the decoder may skip the update operation and directly perform the prediction operation for displacement signals of vertices corresponding to LOD_{N} 810.

In some examples, one or more indications 820 comprises a single indication that indicates whether to enable (e.g., disable or skip) the update operations for all LODs. In some examples, the one or more indications comprises a single indication that indicates one of the LODs whose corresponding update operations are to be enabled (or disabled). For example, the single indication may indicate the lowest LOD level (e.g., last LOD or LOD₀), corresponding to the coarsest resolution, whose associated update operation is to be disabled. This may be useful because there are no more remaining LODs to be processed at the decoder so updated displacement signals at the lowest LOD level are not further used in another lifting operation for a remaining, lower LOD level.

In some examples, one or more indications 820 comprises an indication for each respective LOD of the LODs associated with vertices of the mesh frame. For example, one indication for one LOD may indicate whether update operation in the lifting scheme for that LOD should be enabled or disabled. At the encoder, the encoder may compare compression results between the update operation for the LOD being enabled and disabled to determine whether the indication of the update operation signaled, in a bitstream, to the decoder is enabled or disabled. Then, the decoder may decode the indication, from the bitstream, for the corresponding LOD and selectively perform the update operation for wavelet coefficients of the LOD according to the indication.

In some examples, one or more indications 820 comprises an indication for each respective LOD of the LODs associated with vertices of the mesh frame. But, instead of the encoder comparing compression results between the update operation for the LOD being enabled and disabled to determine whether the indication of the update operation signaled, the encoder may compare compression results between enabling/disabling sets of update operations, corresponding to LODs, to determine a combination of indications that increases (e.g., maximizes) compression gains.

In some examples, an indication of one or more indications 820 may indicate an LOD index identifying an LOD, of LODs of the mesh frame, whose associated update operations are enabled/disabled based on the indication. For example, the indication may include the LOD index and a binary indication (e.g., binary flag) whose value indicates enabling/disabling of the update operation corresponding to the LOD index.

In some examples, one or more indications 820 may be signaled per sequence of 3D mesh frames, per mesh frame, per patch, per patch group, or per LOD. In some examples, the one or more indications comprises an indication that may be signaled per LOD in a mesh frame.

In some embodiments, an indication (e.g., a mode indication) may be signaled in the bitstream indicating whether one or more indications 820, related to selectively applied update operations, are signaled (e.g., are present) in the bitstream. For example, the encoder may determine that performing all of the update operations across all LODs of the mesh frame (i.e., all update operations are enabled and none or skipped/disabled) may provide greatest compression gains. In this case, the mode indication may be signaled (e.g., encoded) to the decoder indicating that one or more indications 820 are not signaled in the bitstream. In these embodiments, if the encoder determines to signal one or more indications 820, the encoder may signal the mode indication indicating a presence of one or more indications 820, e.g., before signaling one or more indications 820.

In some examples, the mode indication may be signaled per sequence of 3D mesh frames, per mesh frame, per patch, or per patch group.

In some embodiments, one or more indications 820 are not signaled between the encoder and the decoder and are predetermined. For example, update operation for displacement signals of vertices at a lowest LOD (e.g., LOD₀ 816) may be disabled without being signaled in one or more indications 820. In some examples, the update operation associated with the lowest LOD are always disabled/skipped and one or more indications 820 indicate which of the update operations corresponding to higher LODs are to be enabled (or alternatively disabled/skipped).

FIG. 9A and FIG. 9B illustrate each iteration of the lifting scheme, described above in FIG. 8B, in greater detail.

FIG. 9A illustrates an example forward lifting scheme to transform displacements of a 3D mesh (e.g., a mesh frame of the 3D mesh) to wavelet coefficients, according to some embodiments. As explained above, the forward lifting scheme may include a plurality of lifting operations that are iteratively performed a number of instances corresponding to a number of LODs of the 3D mesh frame. Each lifting operation may correspond to operations performed in a lifting operator 901. For example, a lifting operator 901A may be applied to input signal 942 corresponding to the displacements (e.g., displacement values determined by the encoder). Split operator 940 may determine odd signal 952 and corresponding even signal(s) 954 for predicting the odd signal 952. For example, odd signal 952 may correspond to a displacement value associated with a vertex, of vertices of the 3D mesh, at a first LOD (e.g., LOD_{N}) of LODs associated with the displacements. Split operator 940 may determine even signal 954 comprising two displacements corresponding to two respective vertices, from one or more lower LODs (e.g., LOD₀-LOD_{N-1}) than the LOD, on a same edge as the vertex. For example, these two vertices may be the closest vertices that sandwich the vertex on the edge and that are from the one or more lower LODs and used to generate the vertex. In some examples, split operator 940 may determine the edge of the vertex based on the subdivided mesh and then determine the two vertices on the same edge, e.g., the two vertices forming that edge.

Prediction filter 960 (e.g., also referred to as prediction step or prediction operation) may generate a displacement predictor for odd signal 952 based on even signal 954 and, in some examples, based on a prediction weight. For example, prediction filter 960 may determine the displacement predictor as an average (e.g., when the prediction weight is one half) of the two even signals represented by even signal 954 for odd signal 952. Prediction filter 960 may convert odd signal 952 (e.g., the displacement at the vertex) into a wavelet coefficient corresponding to prediction error signal 962. For example, prediction error signal 962 may be determined as a difference between odd signal 952 and the displacement predictor. Accordingly, prediction filter 960 may replace odd signal 952 with a difference between odd signal 952 (e.g., original value) and its prediction. Thus, lifting operator 901A may update (e.g., replace) displacement signals in place without requiring separately storing updated signals.

Update filter 970 may update even signal(s) 954 (e.g., displacement signals (e.g., represented by wavelet coefficients) corresponding to vertices v1 and v2) with prediction error signal 962 according to an update weight. Even signal(s) 954 may be converted (e.g., replaced) with updated prediction signal(s) 972. In some examples, when a uniform update weight is applied (e.g., enabled or selected), the update weight may be a predetermined value, e.g., ½, ¼, ⅛, or 1/16. In some examples, when the uniform update weight is applied, a value of the update weight may be signaled by the encoder in the bitstream to the decoder. Accordingly, update filter 970 may replace even signal(s) 952 with updated even signals corresponding to updated prediction signal(s) 972. Updated prediction signal(s) 972 may comprise a sum of a scaled prediction error signal 962 and corresponding even signal(s) 954. Thus, lifting operator 901A may update (e.g., replace) displacement signals in place without requiring separately storing updated signals.

In some embodiments, the encoder may determine whether to apply (e.g., enable or disable/skip) update filter 970 and signal an indication (e.g., one or more indications 820 of FIG. 8B) in the bitstream that indicates its determination. For example, the indication may indicate to skip an update operation/operator associated with an LOD level (e.g., LOD 0). For example, based on determining to skip operation of update filter 970, updated prediction signals 972 may be the same as even signal(s) 954 (which are no longer updated). For example, lifting operator 901A may determine, based on the indication, whether update filter 970 is enabled/disabled before applying update filter 970.

Example pseudo code below shows the encoder determining and signaling indications associated with skipping an update operation in lifting operator 901B corresponding to an LOD:

```
    for (int32_t it = rfmtCount - 1; it >= 0; -- it) {
      // parsing mode indication “skipUpdate”
if (skipUpdate) {
        skip_update_mode = true;
      } else {
              // parsing indication for whether to skip update operation for LOD0 “skiponlylod0”
            if (skiponlylod0 && it == 0) {
              skip_update_mode = true;
            } else {
              skip_update_mode = false;
            }
          }
          const auto vcount0 = infoLevelOfDetails[it].pointCount;
          const auto vcount1 = infoLevelOfDetails[it + 1].pointCount;
          assert(vcount0 < vcount1 && vcount1 <= int32_t(signal.size( )));
          // predict
          for (int32_t v = vcount0; v < vcount1; ++v) {
            const auto edge = edges[v];
            const auto v1 = int32_t(edge & 0xFFFFFFFF);
            const auto v2 = int32_t((edge >> 32) & 0xFFFFFFFF);
            assert(v1 >= 0 && v1 <= vcount0);
            assert(v2 >= 0 && v2 <= vcount0);
            signal[v] -= predWeight * (signal[v1] + signal[v2]);
          }
          // perform update operation if enabled (i.e., not “skip_update_mode”)
          for (int32_t v = vcount0; !skip_update_mode & v < vcount1; ++v) {
            const auto edae = edaes[v]:
            const auto v1 = int32_t(edge & 0xFFFFFFFF);
            const auto v2 = int32_t((edge >> 32) & 0xFFFFFFFF);
            assert(v1 >= 0 && v1 <= vcount0);
assert(v2 >= 0 && v2 <= vcount0);
```

For example, the pseudocode shows the encoder sets a mode indication (“skipUpdate”) that indicates whether all update operations corresponding to all LODs of the mesh frame are to be skipped/disabled. The example pseudocode also shows an example of one or more indications 820 of FIG. 8B (e.g., “skiponlylod0”) that indicates whether update operations corresponding to a specific LOD (e.g., LOD₀) are to be skipped (e.g., disabled).

As shown in FIG. 9A, lifting operations 901A-B are iterated from signal samples (e.g., displacement signals and corresponding wavelet coefficient representations) in higher LODs to lower LODs. In each iteration, lifting operator 901 takes a signal, processed in a previous lifting operation at a higher LOD, and splits (e.g., separates) it into signals corresponding to a lower LOD to generate a predicted and updated signal. Lifting operator 901 is iteratively performed for each lower LOD until the lowest LOD level is processed at which point all displacement signals (e.g., input signal 942) will have been transformed into wavelet coefficients. For example, a base mesh of 900 vertices may be subdivided into an up-sampled mesh with, e.g., 57,600 vertices across 4 LOD levels (e.g., LOD₀ comprising vertices with indexes 1-900, LOD₁ comprising vertices with indexes 901-3600, LOD₂ comprising vertices with indexes 3601-14400, and LOD₃ comprising vertices with indexes 14401-57600). The associated displacements (e.g., displacement values/signals) have the same order as these vertices. Lifting operators 901A-B may iterate from the highest LOD, which is LOD 3 in this example, in lifting operator 901A. Then the lifting operations are executed iteratively, e.g., to lifting operator 901B, etc., until all the signals are processed across all LODs.

FIG. 9B illustrates an example of inverse lifting scheme to transform wavelet coefficients to displacements of a 3D mesh, according to some embodiments. For example, inverse lifting operators 900A-B of the inverse lifting scheme may inverse operation of the lifting scheme described in FIG. 9A. For example, instead of iterating from higher LODs to lower LODs in the forward lifting scheme, lower LODs in the inverse lifting scheme are processed before higher LODs. Previously processed wavelet coefficients may be input as reconstructed updated signal 932 and reconstructed error signal 922 to inverse lifting operator 900B from a previous iteration of the inverse lifting scheme, e.g., from inverse lifting operator 900A.

For example, for a wavelet coefficient (represented by reconstructed error signal 922) of a vertex at an LOD, reconstructed updated signal(s) 932 may be determined corresponding to the two vertices as determined by the forward lifting scheme. Update filter 930 may determine reconstructed even signal(s) 914 based on reconstructed error signal 922 and the update weight (e.g., the same update weight applied by update filter 970 in lifting operator 901A in the forward lifting scheme). Further, prediction filter 920 may determine a displacement predictor based on a prediction weight and updated signals (e.g., reconstructed even signal(s) 914) from update filter 930. Then, prediction filter 920 may combine (e.g., sum) the displacement predictor and the reconstructed error signal 922 to determine reconstructed odd signal 912.

For example, for reconstructed error signal 922 D₁ corresponding to a first vertex, two reconstructed signal(s) 932 Eᵤ₁ and Eᵤ₂ corresponding to a second vertex and a third vertex, respectively, may be determined. As explained above, as similarly performed by the encoder, the decoder may also apply a plurality of iterations of a subdivision scheme to a decoded base mesh (e.g., reconstructed base mesh) to determine a subdivided mesh comprising vertices at a plurality of LODs corresponding to the plurality of iterations. For example, each successive iteration of the subdivision scheme may generate vertices at a next lower LOD. Therefore, for the first vertex from a first LOD, the decoder may determine the second and third vertices, from lower LODs, on the same edge as the first vertex. For example, the second and third vertices may be vertices, from LODs lower than the first LOD, that are closest to the first vertex on the same edge as the first vertex. For example, the second and third vertices may form the edge associated with the first vertex. Then, update filter 930 may generate reconstructed even signals 914 E₁ and E₂ based on reconstructed signal(s) 932 Eᵤ₁ and Eᵤ₂ as follows: E₁=Eᵤ₁−wᵤ*D₁ and E₂=Eᵤ₂−wᵤ*D₁, where wᵤ is the update weight. Accordingly, update filter 930 may replace reconstructed updated signal(s) 932 (e.g., updated from a previous iteration such as inverse lifting operator 900A) with reconstructed even signal(s) 914. Thus, inverse lifting operator 900B may update (e.g., replace) displacement signals in place without requiring separately storing updated signals.

Prediction filter 920 may determine a prediction P₁ for a displacement signal corresponding to the first vertex as follows: P₁=wₚ*(E₁+E₂) where wₚ is the update weight. For example, wₚ may be set to one half such that the prediction P₁ represents an average of the two reconstructed signal(s) 914 E₁ and E₂ after update operation of update filter 930, e.g., as explained with respect to inverse lifting scheme 804B of FIG. 8B. Finally, reconstructed odd signal 912 O₁ may be determined based on (e.g., a sum of) the prediction P₁ and the prediction error P₁ as follows: O₁=D₁+P₁. Accordingly, prediction filter 920 may replace reconstructed error signal 922 (e.g., corresponding or representing a displacement signal of an odd signal) with reconstructed odd signal 912. For example, prediction filter 920 may determine reconstructed odd signal 912 based on a linear combination of reconstructed even signal 914, e.g., by averaging the two signals of reconstructed even signals 914.

Merge operator 910 may order reconstructed odd signal 912 and reconstructed even signal(s) 914 to be further processed at a next higher LOD corresponding to a next inverse lifting operator 900.

In some embodiments, the inverse lifting operator 900B (of the decoder) may determine whether to apply (e.g., enable or disable/skip) update filter 930 based on an indication (e.g., one or more indications 820 of FIG. 8B) received in the bitstream, as explained above in FIG. 8B. In some examples, inverse lifting operator 900B may determine, based on the indication, whether update filter 930 is enabled/disabled before applying update filter 930.

For example, the indication may indicate an LOD index, corresponding to inverse lifting operator 900B, and indicate that the update operation of update filter 930 is to be disabled/skipped for the LOD index. In this case, reconstructed updated signal 932 are not updated and update filter 930 may be bypassed such that reconstructed even signal 914 is the same as reconstructed updated signal 932. In some examples, based on the indication indicating that update filter 930 is disabled/skipped, the decoder may set the update weight used by update filter 930 to be 0.

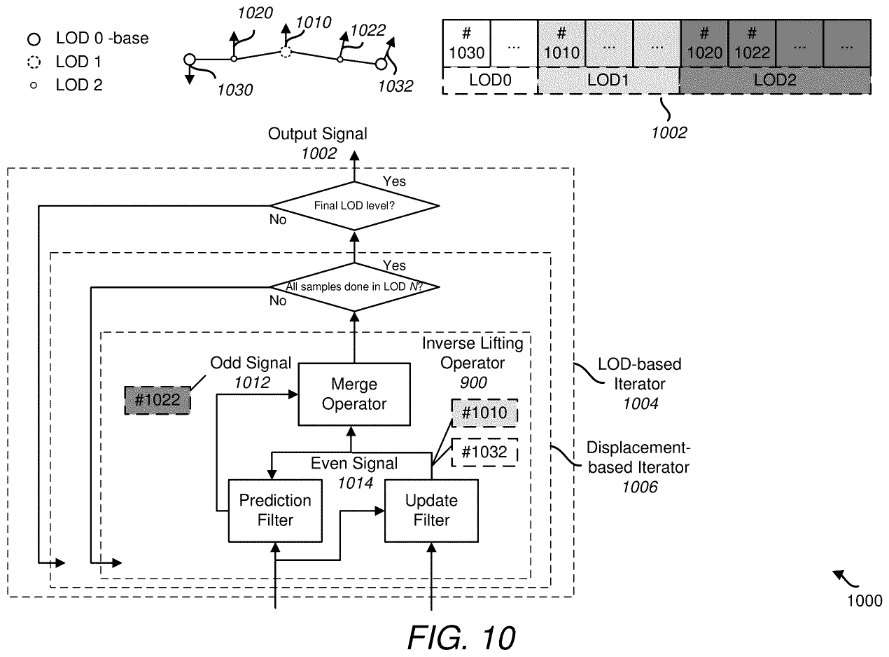

FIG. 10 is a diagram 1000 that illustrates an example of iteratively performing the inverse lifting scheme for each of LODs of vertices in a 3D mesh (e.g., a mesh frame in a sequence of mesh frames), according to some embodiments. For example, vertices of the mesh frame may include respective displacement signals 1030, 1020, 1010, 1022, and 1032 (e.g., displacement values or corresponding wavelet coefficient representations). As explained above, these displacement values may be associated with LODs of the corresponding vertices. Vertices at each higher LOD may be generated by iteratively applying a subdivision scheme, as explained with respect to FIG. 6. For example, displacement signals 1030 and 1032 may correspond to vertices at LOD₀, displacement signal 1010 may correspond to vertices at LOD₁, and displacement signals 1020 and 1022 may correspond to vertices at LOD₂. Displacement signals may be ordered (e.g., shown in array 1002) from lower LODs to higher LODs. For example, displacement signals may be ordered (e.g., arranged) and packed in a 2D image, as described above with respect to FIG. 7B.

As show in diagram 1000, the inverse lifting scheme includes a plurality of iterations of the lifting operation and iterated for each LOD level 1004 until each of the LODs has been processed in a respective lifting operation. For vertices in each LOD, the lifting operation iterates across all displacement signals 1006 (e.g., wavelet coefficient signals/samples) of vertices at that LOD. For example, for LOD₂, inverse lifting operator 900 may be applied to displacement signals of all vertices at LOD₂. For example, for odd signals 1012 of displacement signal 1022 at LOD₂, even signal 1014 corresponding to displacement signals 1010 and 1032 at lower LODs may be determined and processed.

As shown in diagram 1000, after all wavelet coefficient signals/samples have been processed by the inverse lifting transform, samples from a next LOD level is processed until all LODs have been processed by the inverse lifting transform scheme.

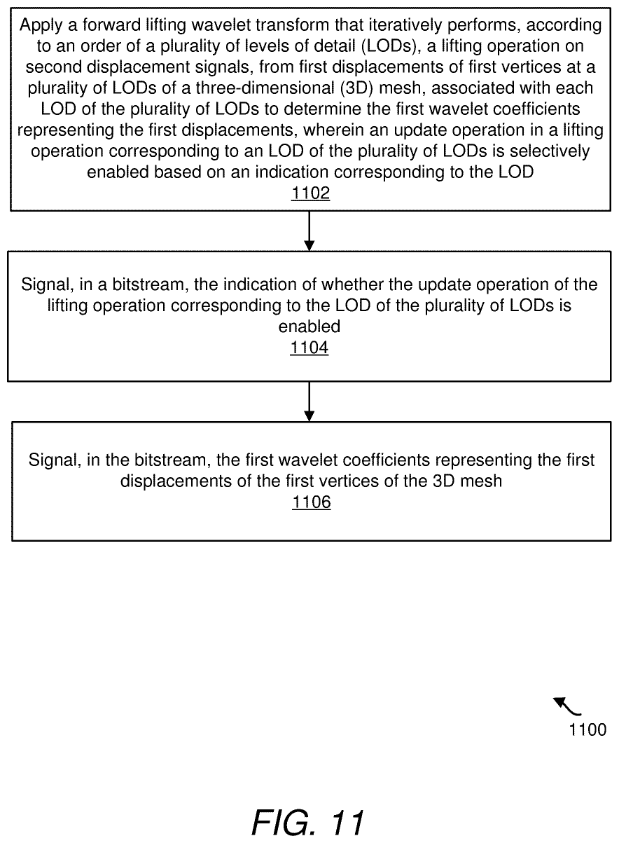

FIG. 11 illustrates a flowchart 1100 of a method for performing a forward lifting scheme, according to some embodiments. In some examples, the method may be performed by an encoder such as encoder 114 of FIG. 1, encoder 200A of FIG. 2A, or encoder 200B of FIG. 2B. The following descriptions of various steps may refer to operations described above with respect to forward lifting scheme 802B of FIG. 8B, or lifting operator 901A of FIG. 9A.

At block 1102, an encoder (e.g., wavelet transformer 210 of FIG. 2A or wavelet transformer 210 of FIG. 2B) applies a forward lifting wavelet transform that iteratively performs, according to an order of a plurality of levels of detail (LODs), a lifting operation on second displacement signals, from first displacements of first vertices at a plurality of LODs of a three-dimensional (3D) mesh, associated with each LOD of the plurality of LODs to determine the first wavelet coefficients representing the first displacements. An update operation in a lifting operation corresponding to an LOD, of the plurality of LODs, is selectively enabled (or disabled/skipped) based on an indication corresponding to the LOD

In some examples, the order of the LODs may be decreasing from higher LODs to lower LODs, as explained above with respect to forward lifting scheme 802B.

In some examples, the encoder may compare compression results of the forward lifting wavelet transform between the update operation, corresponding to the LOD, being disabled and enabled to determine the indication. For example, if compression gains is increased (e.g., less bits being required to be generated in displacement bitstream 260) with the update operation being disabled, the encoder may determine the indication of the update operation, corresponding to the LOD, being disabled.

In some examples, the encoder may determine one or more indications (e.g., one or more indications 820 shown in FIG. 8B) that indicates which update operations, corresponding to the LODs, are to be selectively enabled/disabled (e.g., skipped or not skipped), as explained above with respect to forward lifting scheme 802B in FIG. 8B. For example, the encoder may determine an indication for each respective LOD of the LODs of the 3D mesh (e.g., mesh frame or 3D mesh frame).

In some examples, the one or more indications may be signaled per sequence of 3D mesh frames, per mesh frame, per patch, per patch group, or per LOD.

In some examples, each lifting operation of the forward lifting wavelet transform (e.g., corresponding to forward lifting scheme 802B) may include an update operation and a prediction operation, as described above with respect to FIG. 8B and FIG. 9A. In some examples, based on the update operation for an LOD being disabled, the encoder may set an update weight for the update operation to zero.

For example, each lifting operation may be performed on displacement signals (e.g., displacement values or corresponding wavelet coefficient representations) associated with an LOD of the LODs. The displacement signals may be for vertices at the LOD. For a first displacement signal associated with a first vertex at the LOD (e.g., referred to as an “odd” sample such as odd signal 952 of FIG. 9A), the encoder may determine two vertices (e.g., referred to as “even” signals) from one or more lower LODs than the LOD and on a same edge as the first vertex. As explained above, vertices on lower LODs may be generated based on iteratively applying a subdivision scheme. The two vertices may be the two vertices on an edge that was subdivided by an iteration of the subdivision scheme to determine (e.g., generate) the first vertex of a subdivided mesh. The encoder (e.g., prediction filter 960 of FIG. 9A or prediction operator) determines a displacement prediction for the first displacement signal using a prediction weight and two displacements of the determined edge vertices, i.e., the two vertices. For example, the two displacements may be the “even” samples corresponding to even signal(s) 954 of FIG. 9A. The encoder determines a prediction error (e.g., prediction error signal 962 of FIG. 9A) for the first displacement signal, e.g., based on a difference between the displacement signal and the displacement prediction. The encoder determines if an update operation is enabled (or disabled/skipped) based on the indication. If the update operation is enabled (e.g., not skipped), the encoder (e.g., update filter 970 (or update operator) of FIG. 9A) determines two updated displacement signals for the two displacement signals using an update weight and the determined prediction error.

At block 1104, the encoder signals (e.g., encodes), in a bitstream, the indication of whether the update operation of the lifting operation corresponding to the LOD of the plurality of LODs is enabled. In some examples, the indication may comprise an index of the LOD (e.g., identifying the LOD) and a binary indication of whether the update operation corresponding to the LOD is enabled or disabled (e.g., skipped). In some examples, the indication may be entropy coded, e.g., using a unary code, a Rice code, a Golomb code, an Exp-Golomb code, or the like.

In some examples, the encoder may signal a second indication (e.g., a mode indication) indicating whether the indication (e.g., one or more indications if determined by the encoder) is signaled in the bitstream. For example, the second indication may be signaled before the indication is signaled in block 1104. If the second indication indicates no update operations are to be disabled/skipped, then operation of block 1104 may be omitted. In some examples, the second indication may be entropy coded, e.g., using a unary code, a Rice code, a Golomb code, an Exp-Golomb code, or the like.

At block 1106, the encoder signals (e.g., encodes), in the bitstream, the first wavelet coefficients representing the first displacements of the first vertices of the 3D mesh. In some examples, the first wavelet coefficients are arranged (e.g., packed) by an image packer (e.g., image packer 214 of FIG. 2A and FIG. 2B) into a 2D image (e.g., displacement image 720 in FIG. 7A). In some examples, the first wavelet coefficients may be quantized by a quantizer (e.g., quantizer 212 of FIG. 2A and FIG. 2B) before being arranged by the image packer, as described in FIG. 2A and FIG. 2B. Further, the 2D images may be encoded by a 2D video codec such as video encoder 216 described in FIG. 2A and FIG. 2B.

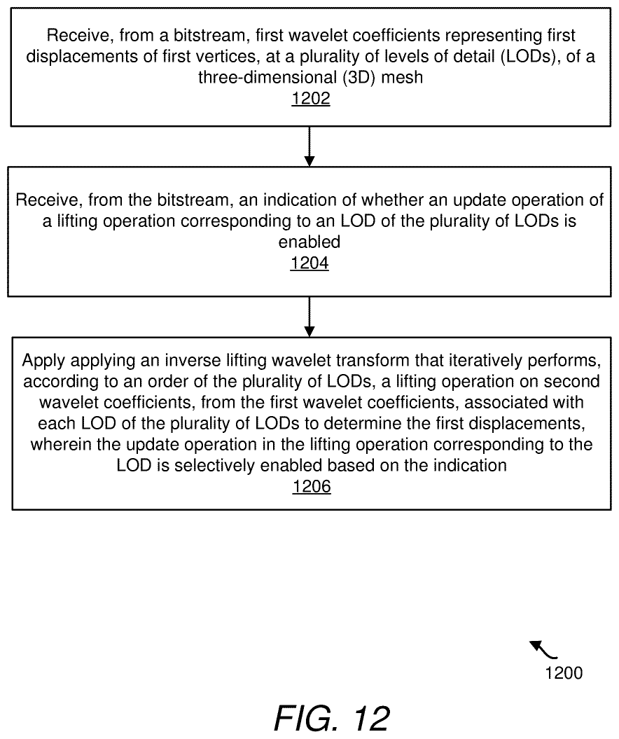

FIG. 12 illustrates a flowchart 1200 of a method for performing an inverse lifting scheme, according to some embodiments. In some examples, the method may be performed by decoder such as decoder 120 of FIG. 1, inverse wavelet transformer 220 of FIG. 2A and FIG. 2B, or inverse wavelet transformer 314 of FIG. 3. The following descriptions of various steps may refer to operations described above with respect to inverse lifting scheme 804B of FIG. 8B, inverse lifting operator 900B of FIG. 9B, or the diagram illustrating operation of an inverse lifting scheme in FIG. 10.

At block 1202, a decoder (e.g., inverse wavelet transformer 220 of FIG. 2A and FIG. 2B, or inverse wavelet transformer 314 of FIG. 3) receives (e.g., decodes), from a bitstream, first wavelet coefficients representing first displacements of first vertices, at a plurality of levels of detail (LODs), of a three-dimensional (3D) mesh.

In some examples, as explained above in FIG. 11, the first wavelet coefficients are arranged (e.g., packed) by an image packer at the encoder into a 2D image (e.g., displacement image 720 in FIG. 7A). Accordingly, the decoder may include a video decoder (e.g., video decoder 308 of FIG. 3) that decodes the 2D image containing the first wavelet coefficients. The decoder may include an image unpacker (e.g., image unpacker 310 of FIG. 3) to reverse (e.g., unpack) operation of the image packer to determine a sequence of first wavelet coefficients. In some examples, the decoder may include an inverse quantizer (e.g., inverse quantizer 312) to inverse quantize the unpacked first wavelet coefficients.

At block 1204, the decoder receives, from the bitstream, an indication (e.g., one or more indications 820 of FIG. 8B) of whether an update operation of a lifting operation corresponding to an LOD of the plurality of LODs is enabled.

In some examples, the indication may comprise an index of the LOD (e.g., identifying the LOD) and a binary indication of whether the update operation corresponding to the LOD is enabled or disabled (e.g., skipped). In some examples, the indication may be entropy coded, e.g., using a unary code, a Rice code, a Golomb code, an Exp-Golomb code, or the like.

In some examples, the decoder may decode a second indication (e.g., a mode indication) indicating whether the indication (e.g., one or more indications if determined by the encoder) is signaled in the bitstream. For example, the second indication may be decoded from the bitstream before the indication is received and decoded in block 1204. If the second indication indicates no update operations are to be disabled/skipped, then operation of block 1204 may be omitted. In some examples, the second indication may be entropy coded, e.g., using a unary code, a Rice code, a Golomb code, an Exp-Golomb code, or the like.

In some examples, the decoder may receive (e.g., decoded) one or more indications (e.g., including the indication received at block 1204) that indicates which update operations, corresponding to the LODs, are to be selectively enabled/disabled (e.g., skipped or not skipped), as explained above with respect to inverse lifting scheme 804B in FIG. 8B. For example, the decoder may decode an indication for each respective LOD of the LODs of the 3D mesh (e.g., mesh frame or 3D mesh frame).

In some examples, the one or more indications may be decoded per sequence of 3D mesh frames, per mesh frame, per patch, per patch group, or per LOD.

At block 1206, the decoder applies an inverse lifting wavelet transform that iteratively performs, according to an order of the plurality of LODs, a lifting operation on second wavelet coefficients, from the first wavelet coefficients, associated with each LOD of the plurality of LODs to determine the first displacements. The update operation in the lifting operation corresponding to the LOD is selectively enabled based on the indication.

In some examples, the order of the LODs may be increasing from lower LODs to higher LODs, as explained above with respect to inverse lifting scheme 804B.

In some examples, each lifting operation of the inverse lifting wavelet transform (e.g., corresponding to inverse lifting scheme 804B) may include an update operation and a prediction operation, as described above with respect to FIG. 8B, FIG. 9B, and FIG. 10. In some examples, based on the update operation for an LOD being disabled by the indication for that LOD, the decoder may set an update weight for the update operation to zero. Accordingly, the indication indicates and corresponds to whether the update weight is set to zero.

In some examples, one or more indications may be received indicating which update operations, corresponding to LODs of the plurality of LODs, are selectively enabled (or disabled/skipped). Accordingly, each lifting operation for each LOD may be performed according to the indication of whether the update operation is enabled (or disabled/skipped) for that LOD.

According to some embodiments, the inverse lifting scheme is described in greater detail below. A decoder may decode from a bitstream, first wavelet coefficients representing first displacements of first vertices, at a plurality of levels of detail (LODs), of a three-dimensional (3D) mesh. The decoder applies an inverse lifting wavelet transform to the first wavelet coefficients to determine the first displacements. The applying the inverse lifting wavelet transform comprises, for each wavelet coefficient corresponding to a vertex, of the first vertices, at an LOD of the plurality of LODs: determining second wavelet coefficients, from the first wavelet coefficients, corresponding to second vertices, of the first vertices, at one or more LODs lower than the first LOD and on an edge comprising the vertex. The decoder may update the second wavelet coefficients based on the wavelet coefficient and an update weight. The decoder may determine a displacement predictor, for a displacement of the vertex, based on the updated second wavelet coefficients. Then, the decoder may convert the wavelet coefficient of the vertex to the displacement, based on the wavelet coefficient and the displacement predictor.

In some examples, the decoder reconstructs a geometry of the 3D mesh based on the first displacements.

In some examples, the decoder decodes a base mesh associated with the 3D mesh, and iteratively applies a subdivision scheme to the base mesh to generate vertices of the subdivided base mesh. Each LOD of the LODs is associated with an iteration of subdivision. For example, the reconstructing the geometry includes: adding the first displacements to corresponding vertices of the subdivided base mesh.

In some examples, a higher LOD is associated with a higher number of iterations of subdivision. In some examples, only the update operation of the lowest LOD is skipped.

In some examples, the decoding the first wavelet coefficients includes: decoding, from the bitstream, an image comprising the first wavelet coefficients, and determining the first wavelet coefficients, from the decoded image, according to a packing order of wavelet coefficients in the decoded image, as described above with respect to FIGS. 7A-B.

In some examples, the decoder inverse quantizes the first wavelet coefficients before performing the inverse lifting wavelet transform such that the inverse lifting wavelet transform is applied to the inverse quantized first wavelet coefficients. In some examples, each wavelet coefficient of the first wavelet coefficients is inverse quantized using a quantization value based on an LOD associated with each wavelet coefficient.

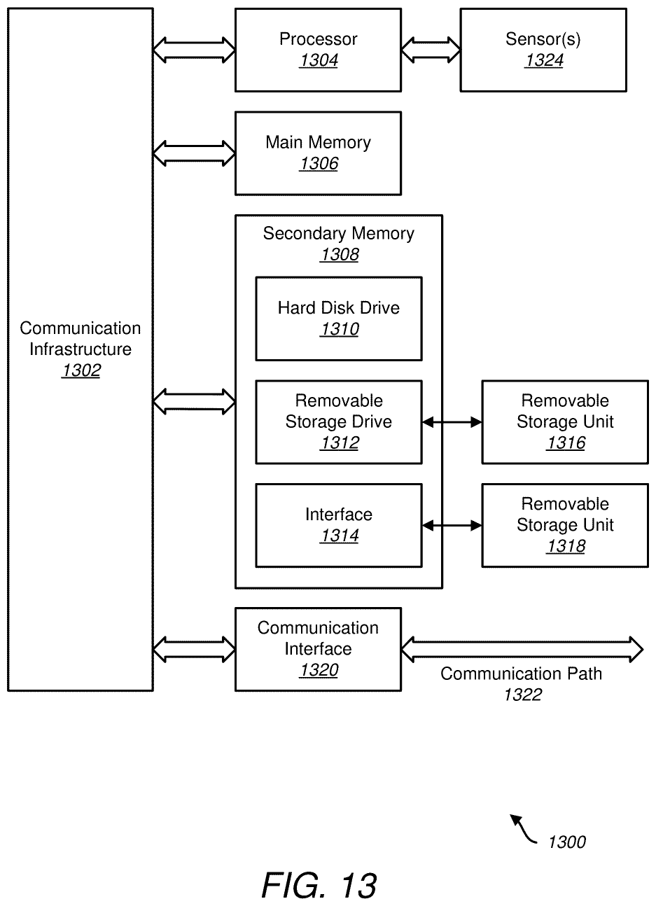

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 1300 is shown in FIG. 13. Blocks depicted in the figures above, such as the blocks in FIG. 1, may execute on one or more computer systems 1300. Furthermore, each of the steps of the flowcharts depicted in this disclosure may be implemented on one or more computer systems 1300. When more than one computer system 1300 is used to implement embodiments of the present disclosure, the computer systems 1300 may be interconnected by one or more networks to form a cluster of computer systems that may act as a single pool of seamless resources. The interconnected computer systems 1300 may form a “cloud” of computers.

Computer system 1300 includes one or more processors, such as processor 1304. Processor 1304 may be, for example, a special purpose processor, general purpose processor, microprocessor, or digital signal processor. Processor 1304 may be connected to a communication infrastructure 1302 (for example, a bus or network). Computer system 1300 may also include a main memory 1306, such as random access memory (RAM), and may also include a secondary memory 1308.

Secondary memory 1308 may include, for example, a hard disk drive 1310 and/or a removable storage drive 1312, representing a magnetic tape drive, an optical disk drive, or the like. Removable storage drive 1312 may read from and/or write to a removable storage unit 1316 in a well-known manner. Removable storage unit 1316 represents a magnetic tape, optical disk, or the like, which is read by and written to by removable storage drive 1312. As will be appreciated by persons skilled in the relevant art(s), removable storage unit 1316 includes a computer usable storage medium having stored therein computer software and/or data.

In alternative implementations, secondary memory 1308 may include other similar means for allowing computer programs or other instructions to be loaded into computer system 1300. Such means may include, for example, a removable storage unit 1318 and an interface 1314. Examples of such means may include a program cartridge and cartridge interface (such as that found in video game devices), a removable memory chip (such as an EPROM or PROM) and associated socket, a thumb drive and USB port, and other removable storage units 1318 and interfaces 1314 which allow software and data to be transferred from removable storage unit 1318 to computer system 1300.

Computer system 1300 may also include a communications interface 1320. Communications interface 1320 allows software and data to be transferred between computer system 1300 and external devices. Examples of communications interface 1320 may include a modem, a network interface (such as an Ethernet card), a communications port, etc. Software and data transferred via communications interface 1320 are in the form of signals which may be electronic, electromagnetic, optical, or other signals capable of being received by communications interface 1320. These signals are provided to communications interface 1320 via a communications path 1322. Communications path 1322 carries signals and may be implemented using wire or cable, fiber optics, a phone line, a cellular phone link, an RF link, and other communications channels.

Computer system 1300 may also include one or more sensor(s) 1324. Sensor(s) 1324 may measure or detect one or more physical quantities and convert the measured or detected physical quantities into an electrical signal in digital and/or analog form. For example, sensor(s) 1324 may include an eye tracking sensor to track the eye movement of a user. Based on the eye movement of a user, a display of a 3D mesh may be updated. In another example, sensor(s) 1324 may include a head tracking sensor to the track the head movement of a user. Based on the head movement of a user, a display of a 3D mesh may be updated. In yet another example, sensor(s) 1324 may include a camera sensor for taking photographs and/or a 3D scanning device, like a laser scanning, structured light scanning, and/or modulated light scanning device. 3D scanning devices may obtain geometry information by moving one or more laser heads, structured light, and/or modulated light cameras relative to the object or scene being scanned. The geometry information may be used to construct a 3D mesh.

As used herein, the terms “computer program medium” and “computer readable medium” are used to refer to tangible storage media, such as removable storage units 1316 and 1318 or a hard disk installed in hard disk drive 1310. These computer program products are means for providing software to computer system 1300. Computer programs (also called computer control logic) may be stored in main memory 1306 and/or secondary memory 1308. Computer programs may also be received via communications interface 1320. Such computer programs, when executed, enable the computer system 1300 to implement the present disclosure as discussed herein. In particular, the computer programs, when executed, enable processor 1304 to implement the processes of the present disclosure, such as any of the methods described herein. Accordingly, such computer programs represent controllers of the computer system 1300.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

What is claimed is:

1. A method comprising:
receiving, from a bitstream, first wavelet coefficients representing first displacements of first vertices of a three-dimensional (3D) mesh, wherein the first vertices are at a plurality of levels of detail (LODs);
receiving, from the bitstream, an indication of whether an update weight, specific to an LOD of the plurality of LODs, in an update operation of a lifting operation corresponding to the LOD is set to zero; and
applying an inverse lifting wavelet transform that iteratively performs, according to an order of the plurality of LODs, a lifting operation on second wavelet coefficients, from the first wavelet coefficients, associated with each LOD of the plurality of LODs to determine the first displacements, wherein the update weight for the update operation in the lifting operation, corresponding to the LOD, is set based on the indication.

2. The method of claim 1, wherein the update weight being set to zero corresponds to the update operation being skipped or disabled for the lifting operation corresponding to the LOD.

3. The method of claim 1, further comprising:
receiving, from the bitstream, a plurality of indications indicating which update operations, of lifting operations corresponding to the plurality of LODs, are performed, wherein the plurality of indications comprise the indication.

4. The method of claim 3, wherein one or more update operations, of the update operations, being not performed corresponds to one or more indications, of the plurality of indications, indicating one or more update weights, corresponding to the one or more update operations, being set to zero.

5. The method of claim 1, wherein the indication is associated with:
a sub-mesh of the 3D mesh;
a 3D mesh frame comprising the 3D mesh; or
a sequence of 3D meshes comprising the 3D mesh.

6. The method of claim 1, further comprising:
receiving a second indication of a presence of the indication, wherein the second indication is received before the receiving the indication and indicates that not all update operations of all lifting operations of the plurality of LODs are disabled.

7. The method of claim 1, wherein the performing the lifting operation on the second wavelet coefficients comprises:
determining a pair of wavelet coefficients, from the first wavelet coefficients and for a wavelet coefficient of the second wavelet coefficients, that form an edge associated with a vertex corresponding to the wavelet coefficient, wherein the pair of wavelet coefficients are at one or more LODs lower than the LOD of the vertex;
determining, based on the indication, whether to update the pair of wavelet coefficients based on an update weight; and
converting, based on the wavelet coefficient and a displacement predictor determined based on whether to update the pair of wavelet coefficients, the wavelet coefficient of the vertex to a displacement of the first displacements.

8. A decoder comprising:
one or more processors; and
memory storing instructions that, when executed by the one or more processors, cause the decoder to:
receive, from a bitstream, first wavelet coefficients representing first displacements of first vertices of a three-dimensional (3D) mesh, wherein the first vertices are at a plurality of levels of detail (LODs);
receive, from the bitstream, an indication of whether an update weight, specific to an LOD of the plurality of LODs, in an update operation of a lifting operation corresponding to the LOD is set to zero; and
apply an inverse lifting wavelet transform that iteratively performs, according to an order of the plurality of LODs, a lifting operation on second wavelet coefficients, from the first wavelet coefficients, associated with each LOD of the plurality of LODs to determine the first displacements, wherein the update weight for the update operation in the lifting operation, corresponding to the LOD, is set based on the indication.

9. The decoder of claim 8, wherein the update weight being set to zero corresponds to the update operation being skipped or disabled for the lifting operation corresponding to the LOD.

10. The decoder of claim 8, wherein the instructions further cause the decoder to:
receive, from the bitstream, a plurality of indications indicating which update operations, of lifting operations corresponding to the plurality of LODs, are performed, wherein the plurality of indications comprise the indication.

11. The decoder of claim 10, wherein one or more update operations, of the update operations, being not performed corresponds to one or more indications, of the plurality of indications, indicating one or more update weights, corresponding to the one or more update operations, being set to zero.

12. The decoder of claim 8, wherein the indication is associated with:
a sub-mesh of the 3D mesh;
a 3D mesh frame comprising the 3D mesh; or
a sequence of 3D meshes comprising the 3D mesh.

13. The decoder of claim 8, wherein the instructions further cause the decoder to:
receive a second indication of a presence of the indication, wherein the second indication is received before the receiving the indication and indicates that not all update operations of all lifting operations of the plurality of LODs are disabled.

14. The decoder of claim 8, wherein to perform the lifting operation on the second wavelet coefficients, the instructions further cause the decoder to:
determine a pair of wavelet coefficients, from the first wavelet coefficients and for a wavelet coefficient of the second wavelet coefficients, that form an edge associated with a vertex corresponding to the wavelet coefficient, wherein the pair of wavelet coefficients are at one or more LODs lower than the LOD of the vertex;
determine, based on the indication, whether to update the pair of wavelet coefficients based on an update weight; and
convert, based on the wavelet coefficient and a displacement predictor determined based on whether to update the pair of wavelet coefficients, the wavelet coefficient of the vertex to a displacement of the first displacements.

15. A non-transitory computer-readable medium comprising instructions that, when executed by one or more processors of a decoder, cause the decoder to:
receive, from a bitstream, first wavelet coefficients representing first displacements of first vertices of a three-dimensional (3D) mesh, wherein the first vertices are at a plurality of levels of detail (LODs);
receive, from the bitstream, an indication of whether an update weight, specific to an LOD of the plurality of LODs, in an update operation of a lifting operation corresponding to the LOD is set to zero; and
apply an inverse lifting wavelet transform that iteratively performs, according to an order of the plurality of LODs, a lifting operation on second wavelet coefficients, from the first wavelet coefficients, associated with each LOD of the plurality of LODs to determine the first displacements, wherein the update weight for the update operation in the lifting operation, corresponding to the LOD, is set based on the indication.

16. The non-transitory computer-readable medium of claim 15, wherein the update weight being set to zero corresponds to the update operation being skipped or disabled for the lifting operation corresponding to the LOD.

17. The non-transitory computer-readable medium of claim 15, wherein the instructions further cause the decoder to:
receive, from the bitstream, a plurality of indications indicating which update operations, of lifting operations corresponding to the plurality of LODs, are performed, wherein the plurality of indications comprise the indication.

18. The non-transitory computer-readable medium of claim 17, wherein one or more update operations, of the update operations, being not performed corresponds to one or more indications, of the plurality of indications, indicating one or more update weights, corresponding to the one or more update operations, being set to zero.

19. The non-transitory computer-readable medium of claim 15, wherein the instructions further cause the decoder to:
receive a second indication of a presence of the indication, wherein the second indication is received before the receiving the indication and indicates that not all update operations of all lifting operations of the plurality of LODs are disabled.

20. The non-transitory computer-readable medium of claim 15, wherein to perform the lifting operation on the second wavelet coefficients, the instructions further cause the decoder to:
determine a pair of wavelet coefficients, from the first wavelet coefficients and for a wavelet coefficient of the second wavelet coefficients, that form an edge associated with a vertex corresponding to the wavelet coefficient, wherein the pair of wavelet coefficients are at one or more LODs lower than the LOD of the vertex;
determine, based on the indication, whether to update the pair of wavelet coefficients based on an update weight; and
convert, based on the wavelet coefficient and a displacement predictor determined based on whether to update the pair of wavelet coefficients, the wavelet coefficient of the vertex to a displacement of the first displacements.
